(19) United States
(12) Patent Application Publication
(10) Pub. No.: US 2007/0122596 A1
(43) Pub. Date: May 31, 2007

(54) Electrophotographic image-receiving sheet, process for manufacturing the same and process for image formation using the same

(75) Inventors: Shigehisa Tamagawa, Shizuoka (JP); Ashita Murai, Shizuoka (JP); Yukio Hirashima, Shizuoka (JP); Yasuhiro Ogata, Shizuoka (JP); Yoshio Tani, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/657,655

(22) Filed: Jan. 25, 2007

Related U.S. Application Data
(62) Division of application No. 10/459,528, filed on Jun. 12, 2003.

(30) Foreign Application Priority Data
Jun. 12, 2002 (JP) 2002-171130
Jun. 12, 2002 (JP) 2002-171131
Jun. 12, 2002 (JP) 2002-171128
Nov. 22, 2002 (JP) 2002-339498

(51) Int. Cl. B41M 5/00

(52) U.S. Cl. 428/195.1

(57) ABSTRACT

The present invention aims to provide an electrophotographic image-receiving sheet which can be more easily and efficiently manufactured and shows excellent image quality and glossiness, to provide a process for manufacturing the electrophotographic image-receiving sheet, and to provide a process for image formation using the electrophotographic image-receiving sheet. An electrophotographic image-receiving sheet which includes a support and a toner image-receiving layer which is to be disposed on at least one surface of the support and contains a thermoplastic resin, in which the electrophotographic image-receiving sheet is formed by soft calender treatment using a metal roller having surface temperature of glass transition temperature (Tg) of the thermoplastic resin minus 30° C. or more and the glass transition temperature plus 50° C. or less, so that the metal roller contacts a surface of the toner image-receiving layer.

### BACKGROUND OF THE INVENTION

1. Field of the Invention

The present invention relates to an electrophotographic image-receiving sheet used in machines that utilize a process for electrophotography, such as copiers, printers and facsimile machines, more specifically color copiers, and gives excellent images and glossy toner images, to a process for manufacturing the electrophotographic image-receiving sheet, and to a process for image formation using the electrophotographic image-receiving sheet.

2. Description of the Related Art

In general commercial printing and high-class printing, offset printing is used. Treated paper, such as art paper and coat paper, is used. This is because, as the surface of coat paper is flat and smooth, ink transport properties are good, image reproducibility and glossiness are high, and color reproducibility is also good.

However, since the coating layer of coat paper contains a large amount of pigment and is highly hygroscopic, if coat paper itself is used as an electrophotographic image-receiving sheet and the image is fixed by heat, steam expands in the coat paper and blistering (swelling of the coating layer) is produced between a support and the coating layer. As a result, the image is ruined, and fine images such as those of silver halide photography cannot be obtained.

With conventional coat paper, when outputting image information such as faces and scenery as a photograph, there is also a problem that glossiness is deteriorated. Therefore, until now, coat paper has hardly ever been used as an electrophotographic image-receiving sheet.

It has been proposed to perform machine calendering treatment to the raw paper in the electrophotographic image-receiving sheet (Japanese Patent Application Laid-Open (JP-A) No. 05-341553 and JP-A No. 08-72394). In these proposals, the nip width is small and there is a small contact area between the raw paper and a roller. Therefore, an image having a satisfactory quality and glossiness cannot be obtained.

It has also been proposed to subject the pigment, which is a main component of a coating layer of the electrophotographic image-receiving sheet to soft calendar treatment, with a metal roller at 100° C. or more (JP-A No. 07-219262). However, in this proposal, image quality and glossiness are unsatisfactory, and further improvement has been desired.

### SUMMARY OF THE INVENTION

It is therefore an object of the present invention to provide an electrophotographic image-receiving sheet which can be manufactured more easily and efficiently than the electrophotographic image-receiving sheet of the related art, and which offers a toner image of excellent image quality and glossiness. It is also an object of the present invention to provide a process for manufacturing the electrophotographic image-receiving sheet, and to provide a process for image formation using the electrophotographic image-receiving sheet.

The electrophotographic image-receiving sheet of the present invention comprises, in a first aspect, a support and a toner image-receiving layer which is to be disposed on at least one surface of the support and contains a thermoplastic resin. In the electrophotographic image-receiving sheet of the first aspect is formed by soft calender treatment using a metal roller having surface temperature of glass transition temperature (Tg) of the thermoplastic resin minus 30° C. or more and the glass transition temperature plus 50° C. or less, so that the metal roller contacts a surface of the toner image-receiving layer.

The electrophotographic image-receiving sheet of the present invention, in a second aspect, comprises a support and a toner image-receiving layer which is to be disposed on at least one surface of the support and contains a thermoplastic resin and a pigment. In the electrophotographic image-receiving sheet of the second aspect, a surface of the support on which the toner image-receiving layer is to be disposed has a glossiness of 25% or more in a 75° glossiness specified by JIS P8142, a content of the pigment is less than 40% by mass based on a mass of the thermoplastic resin.

By using the electrophotographic image-receiving sheet according to the first and second aspect of the present invention, a toner image having the same image quality and glossiness as a silver halide photograph is obtained.

The process for manufacturing an electrophotographic image-receiving sheet of the present invention comprises the steps of subjecting a surface of a support on which a toner image-receiving layer is to be disposed, to soft calender treatment using a metal roller having surface temperature of 150° C. or higher, and of subjecting a surface of the toner image-receiving layer to soft calender treatment using a metal roller having surface temperature of glass transition temperature (Tg) of the thermoplastic resin minus 30° C. or more and the glass transition temperature plus 50° C. or less, so that the metal roller contacts a surface of the toner image-receiving layer. In this way, it is possible to manufacture an electrophotographic image-receiving sheet having excellent toner image quality and glossiness more easily and with higher efficiency than those in the related art.

The process for image formation of the present invention comprises the steps of forming a toner image on an electrophotographic image-receiving sheet according to the present invention, of heating and pressurizing a surface of the electrophotographic image-receiving sheet on which the toner image is formed by a fixing belt and a fixing roller, and of cooling the surface so as to separate the electrophotographic image-receiving sheet from the fixing belt. In this way, even if an oil-less machine where no fixing oil is used, separation of the electrophotographic image-receiving sheet and toner, or offset of the electrophotographic image-receiving sheet and toner, can be prevented, stable paper feed can be realized, and a good image having unprecedented glossiness which is rich in photographic texture can be obtained.

### BRIEF DESCRIPTION OF THE DRAWINGS

FIG. 1 is a schematic view showing an example of the fixing part of an apparatus for electrophotography according to the present invention.

FIG. 2 is a schematic view showing an example of the fixing part of an apparatus for electrophotography used in the EXAMPLEs.

### DESCRIPTION OF THE PREFERRED EMBODIMENTS

(Electrophotographic Image-Receiving Sheet of the First Aspect)

The electrophotographic image-receiving sheet according to a first aspect of the present invention comprises a support and a toner image-receiving layer which contains a thermoplastic resin on at least one surface of the support, and the toner image-receiving layer is formed by soft calender treatment so that a metal roller having a surface temperature equal to or higher than the glass transition temperature (Tg) of the thermoplastic resin in the toner image-receiving layer −30° C. and less than the glass transition temperature (Tg) of the thermoplastic resin in the toner image-receiving layer +50° C., comes in contact with the surface of the toner image-receiving layer.

Soft calender treatment is performed so that the surface temperature of the metal roller in the soft calender treatment is equal to or more than the glass transition temperature (Tg) −30° C. of the thermoplastic resin in the toner image-receiving layer, and a metal roller having a surface temperature of less than the glass transition temperature (Tg) +50° C. of the thermoplastic resin in the toner image-receiving layer is brought into contact with the surface of the toner image-receiving layer.

It is however preferred that in the soft calender treatment, the metal roller has a surface temperature equal to or higher than the glass transition temperature (Tg) of the thermoplastic resin in the toner image-receiving layer −30° C. but less than the glass transition temperature (Tg) of the thermoplastic resin in the toner image-receiving layer +20° C.

If the surface temperature of the metal roller is more than the glass transition temperature (Tg) +50° C., there is a problem of sticking to the calender roller. On the other hand, if it is less than the glass transition temperature (Tg) −30° C., there is insufficient improvement of flatness and glossiness.

Herein, the glass transition temperature (Tg) of the thermoplastic resin in the toner image-receiving layer is preferably 40° C. to 80° C. Therefore, the surface temperature of the metal roller is preferably less than 150° C., and more preferably less than 100° C.

If the glass transition temperature (Tg) of the thermoplastic resin in the toner image-receiving layer is less than 40° C., belt adhesion may occur during fixing the toners. If it is more than 80° C., the toner may not penetrate into the toner image-receiving layer properly and the quality of the image may deteriorate.

The soft calender treatment may for example be performed by using a pair of calender rollers, at least one of which is a metal roller.

Examples of these calender rollers include soft calender rollers comprising a combination of a metal roller and a synthetic resin roller, machine calender rollers comprising a pair of metal rollers, and the like. A long nip calender comprising a metal roller and a shoe roller via a synthetic resin belt is preferred, having a nip width of as large as 50 mm to 270 mm, and enabling increasing the contact area between the toner image-receiving layer and roller.

Soft calender treatment can be carried out by the aforesaid calender treatments alone or in combination of two or more.

The nip pressure in the aforesaid soft calender treatment is, for example, preferably 100 kN/m or more, and more preferably 100 kN/m to 600 kN/m.

In the aforesaid first aspect, it is preferred that a surface of the support on which the toner image-receiving layer is formed is soft calender treated by a metal roller having a surface temperature of 150° C. or more. The surface temperature of the metal roller is, for example, preferably 150° C. or more, more preferably 200° C. or more, and still more preferably 250° C. or more. The upper limit of the metal surface temperature may, for example, be around 300° C.

The aforesaid metal surface may for example be a metal roller surface. Calender treatment using the metal surface may be performed by using a pair of calender rollers, at least one of which is a metal roller.

These calender rollers may for example be soft calender rollers comprising a combination of a metal roller and a synthetic resin roller, or machine calender rollers comprising a pair of metal rollers. Of these, soft calender rollers are preferable, in particular a shoe calender having long nip which comprises a metal roller and a shoe roller via a synthetic resin belt having a nip width of as large as 50 mm to 270 mm, which is preferred from a viewpoint of increasing the contact area between the raw paper and the rollers.

Calender treatment may include the aforesaid calender treatments used alone or in combination.

A nip pressure when the support is subjected to soft calender treatment is for example preferably 100 kN/m or more, and more preferably 100 kN/m to 600 kN/m.

(Electrophotographic Image-Receiving Sheet of the Second Aspect)

The electrophotographic image-receiving sheet according to the second aspect of the present invention comprises a support and a toner image-receiving layer formed on at least one surface of the support. The glossiness (75° glossiness), as specified by JIS P8142, of the surface of the support on which the toner image-receiving layer is formed, is 25% or more, and the content of the pigment in the toner image-receiving layer is less than 40% by mass based on the mass of thermoplastic resin which forms the toner image-receiving layer.

The content of the pigment in the toner image-receiving layer is preferably less than 40% by mass, more preferably less than 25% by mass and still more preferably less than 20% by mass based on the mass of thermoplastic resin forming the toner image-receiving layer, and it is particularly preferred that it contains no pigment (0% by mass) at all. If the proportion of pigment is large, blistering easily occurs, and the toner image obtained may become uneven.

The glossiness (75° glossiness) specified by JIS P8142 of the surface of the support (preferably raw paper) on which the toner image-receiving layer is formed, is preferably 25% or more, and more preferably 35% or more. The upper limit of the glossiness is preferably of around 50%.

In the related art, a raw paper surface having a very high glossiness was not coated with a coating solution. In the related art, raw paper of coat paper used as an electrophotographic image-receiving sheet has the glossiness on the surface of only 15% or so.

A raw paper having this high glossiness may for example be prepared by performing advanced calender treatment on the surface (hereinafter, simply referred to as “top surface”) of the raw paper on which the toner image-receiving layer is to be disposed.

For example, a surface having a glossiness of 25% or more may be formed by applying a hot metal surface of a roller to the top surface of the raw paper.

The temperature of the metal surface is for example preferably 150° C. or more, more preferably 200° C. or more and still more preferably 250° C. or more. The upper limit of the temperature of the metal surface may for example be around 300° C.

In the related art, even if calender treatment is given to the raw paper surface before applying a coating solution, it appears that the temperature is no more than about 90° C. In calender treatment using a metal surface at this temperature (less than around 90° C.), the glossiness of the raw paper surface would for example be around 12%.

The aforesaid metal surface may for example be the surface of a metal roller. Calender treatment using this metal surface may for example be performed by using a pair of calender rollers, at least one of which is a metal roller.

Examples of the calender rollers include soft calender rollers comprising a combination of a metal roller and a synthetic resin roller, machine calender rollers comprising a pair of metal rollers, and the like.

A long nip calender comprising a metal roller and a shoe roller via a synthetic resin belt can also be used.

The calender treatment may include the aforesaid calender treatments used alone or in combination.

There is no particular limitation on the nip pressure when the raw paper is treated which may be suitably selected according to the purpose. For example, the nip pressure is preferably 49 kN/m (50 kgf/cm) or more, more preferably 98 kN/m (100 kgf/cm) or more, and still more preferably 147 kN/m (150 kgf/cm) or more. The upper limit of the nip pressure is preferably around 392 kN/m (400 kgf/cm).

The electrophotographic image-receiving sheet of the first and second aspects of the present invention comprises a support and a toner image-receiving layer which is to be disposed on at least one surface of this support. The electrophotographic image-receiving sheet may also comprise other layers which may be suitably selected if necessary. Examples of the other layers include a surface protection layer, an intermediate layer, an underlayer, a cushion layer, a static control (prevention) layer, a reflection layer, a color tone adjusting layer, a storage property improvement layer, an antistick layer, an anticurl layer, a smoothing layer, and the like. These layers may have a single-layer structure or a laminated structure.

The elements of these layers will now be described in detail hereinafter.

[Support]

There is no particular limitation on the support as long as it satisfies requirements regarding ability to withstand the fixing temperature, smoothness, whiteness, slidability, frictional properties, antistatic properties, or the like, and may be suitably selected according to the purpose. Examples of the support include raw paper, synthetic paper, a synthetic resin sheet, coat paper, laminated paper, and the like. The support may have a single layer, or it may have a laminated structure of two or more layers.

The raw paper may be a high quality paper, for example, the paper described in Basic Photography Engineering—Silver Halide Photography, CORONA PUBLISHING CO., LTD. (1979) pp. 223-240, edited by the Institute of Photography of Japan.

The materials of the raw paper (including synthetic paper) may be those types of raw paper used as supports in the art, which can be selected from various kinds of materials without any particular limitation. Examples of the materials of the raw paper include natural pulp selected from needle-leaf trees and broadleaf trees, synthetic pulp made from plastics materials such as polyethylene, polypropylene, or the like, a mixture of the natural pulp and the synthetic pulp, and the like.

Regarding pulps used as materials for the raw paper, from the viewpoint of good balance between surface flatness and smoothness of the raw paper, rigidity and dimensional stability (curl), broadleaf tree bleached kraft pulp (LBKP) is preferred. Needle-leaf bleached kraft pulp (NBKP), broadleaf tree sulfite pulp (LBSP), or the like can also be used.

A beater or a refiner, or the like, can be used for beating the pulp.

Canadian standard freeness of the pulp is preferably 200 ml C.S.F to 440 ml C.S.F, and more preferably 250 ml C.S.F to 380 ml C.S.F, from the viewpoint of controlling contraction of paper at a paper-manufacturing step.

Various additives, for example, fillers, dry paper reinforcers, sizing agents, wet paper reinforcers, fixing agents, pH regulators or other agents, or the like may be added, if, necessary, to the pulp slurry (hereafter, may be referred to as pulp paper material) which is obtained after beating the pulp.

Examples of the fillers include calcium carbonate, clay, kaolin, white clay, talc, titanium oxide, diatomaceous earth, barium sulfate, aluminum hydroxide, magnesium hydroxide, and the like.

Examples of the dry paper reinforcers include cationic starch, cationic polyacrylamide, anionic polyacrylamide, amphoteric polyacrylamide, carboxy-modified polyvinyl alcohol, and the like.

Examples of the sizing agents include rosin derivatives such as aliphatic salts, rosin, maleic rosin or the like; paraffin wax, alkyl ketene dimer, alkenyl succinic anhydride (ASA), epoxy aliphatic amide, and the like.

Examples of the wet paper reinforcers include polyamine polyamide epichlorohydrin, melamine resin, urea resin, epoxy polyamide resin, and the like.

Examples of the fixing agents include polyfunctional metal salts such as aluminum sulfate, aluminum chloride, or the like; cationic polymers such as cationic starch, or the like.

Examples of the pH regulators include caustic soda, sodium carbonate, and the like.

Examples of other agents include defoaming agents, dyes, slime control agents, fluorescent whitening agents, and the like.

Moreover, softeners can also be added if necessary. An example of the softeners is disclosed on pp. 554-555 of Paper and Paper Treatment Manual (Shiyaku Time Co., Ltd.) (1980).

Treatment liquids used for sizing a surface may include water-soluble polymers, waterproof materials, pigments, dyes, fluorescent whitening agents, and the like.

Examples of water-soluble polymers include cationic starch, polyvinyl alcohol, carboxy-modified polyvinyl alcohol, carboxymethylcellulose, hydroxyethylcellulose, cellulose sulfite, gelatin, casein, sodium polyacrylate, styrene-maleic anhydride copolymer sodium salt, sodium polystyrene sulfonate, and the like.

Examples of the waterproof materials include latex emulsions such as styrene-butadiene copolymer, ethylene-vinyl acetate copolymer, polyethylene, vinylidene chloride copolymer or the like; polyamide polyamine epichlorohydrin, and the like.

Examples of the pigments include calcium carbonate, clay, kaolin, talc, barium sulfate, titanium oxide, and the like.

Examples of the raw paper materials include, in addition to the natural pulps, synthetic pulp paper, mixtures of the natural pulp and the synthetic pulp, various types of composite paper, and the like.

As for the above raw paper, to improve the rigidity and dimensional stability (curl) of the electrophotographic image-receiving sheet, it is preferred that the ratio (Ea/Eb) of the longitudinal Young's modulus (Ea) and the lateral Young's modulus (Eb) is within the range of 1.5 to 2.0. If the ratio (Ea/Eb) is less than 1.5 or more than 2.0, the rigidity and curl of the electrophotographic image-receiving sheet tend to deteriorate, and may interfere with paper when transported.

In the present invention, the Oken type smoothness of a surface of the toner image-receiving layer of the raw paper is 210 seconds or more, and preferably 250 seconds or more. If the Oken type smoothness is less than 210 seconds, the quality of the toner image is poor. There is no particular limitation on the upper limit of the Oken type smoothness. However, in practice, about 600 seconds, and preferably about 500 seconds are suitable.

Here, the Oken type smoothness refers to the smoothness specified by the JAPAN TAPPI No. 5 B method.

It has been found that, in general, the “tone” of the paper differs based on differences in the way the paper is beaten, and the elasticity (modulus) of paper from paper-making after beating can be used as an important indication of the “tone” of the paper.

The elastic modulus of the paper can be calculated from the following equation by using the relation of the density and the dynamic modulus which shows the physical properties of a viscoelastic object, and by measuring the velocity of sound propagation in the paper using an ultrasonic oscillator.
E=ρc²(1−n²)
[E=dynamic modulus, ρ=density, c=velocity of sound in paper, n=Poisson's ratio]

As n=0.2 or so in a case of ordinary paper, there is not much difference in the calculation, even if the calculation is performed by the following equation:
E=ρc²

Namely, if the density of the paper and acoustic velocity can be measured, the elastic modulus can easily be calculated. In the above equation, when measuring acoustic velocity, various instruments known in the art may be used, such as a Sonic Tester SST-110 (Nomura Shoji Co., Ltd.) or the like.

The thickness of the raw paper is preferably 30 μm to 500 μm, and more preferably 50 μm to 300 μm, and still more preferably 100 μm to 250 μm. The weighting of the raw paper is for example preferably 50 g/m² to 250 g/m², and more preferably 100 g/m² to 200 g/m².

In the raw paper, it is preferred to use pulp fibers having a fiber length distribution as disclosed, for example, in Japanese Patent Application Laid-Open (JP-A) No. 58-68037 (for example, the sum of 24-mesh screen residue and 42-mesh screen residue is 20% by mass to 45% by mass, and 24-mesh screen residue is 5% by mass or less) in order to give the desired center line average roughness to the surface. Moreover, the center line average roughness can be adjusted by heating and giving a pressure to a surface of the raw paper, with a machine calendar, super calendar, or the like.

—Synthetic Resin Sheet—

The synthetic resin sheet may be a synthetic resin formed in the shape of a sheet (film). The synthetic resin sheet may for example be obtained by extrusion molding polyolefin resin such as polypropylene resin or the like, or polyester resins such as polyethylene-terephthalate resin, or the like, into a shape of a sheet.

—Coated Paper—

The coated paper is paper or a sheet on one surface or both surfaces of which is coated with rubber latex, polymer materials, or the like. The amount to be coated differs according to the use. Examples of the coated paper include art paper, cast coated paper, Yankee paper, and the like.

If a resin is used to coat the surface of raw paper, for example, it is appropriate to use a thermoplastic resin. Examples of the thermoplastic resins include the thermoplastic resins of the following (a) to (h).

(a) Polyolefin resins such as polyethylene resin, polypropylene resin, or the like; copolymer resins of an olefin such as ethylene or propylene with other vinyl monomers; acrylic resins, and the like.

(b) Thermoplastic resins containing at least an ester bond. For example, polyester resins obtained by condensation of dicarboxylic acid components (these dicarboxylic acid components may be substituted by a sulfonic acid group, a carboxyl group, and the like.) and alcoholic components (these alcoholic components may be substituted by the hydroxyl group, and the like), polyacrylic acid ester resins or polymethacrylic acid ester resins such as polymethylmethacrylate, polybutylmethacrylate, polymethylacrylate, polybutylacrylate, and the like; polycarbonate resin, polyvinyl acetate resin, styrene acrylate resin, styrene-methacrylic acid ester copolymer resin, vinyltoluene acrylate resin, and the like.

Specifically, the resins described in JP-A Nos. 59-101395, 63-7971, 63-7972, 63-7973, 60-294862, or the like may be mentioned.

Examples of commercial products include Bailon 290, Bailon 200, Bailon 280, Bailon 300, Bailon 103, Bailon GK-140 and Bailon GK-130 from Toyobo Co., Ltd; Tufton NE-382, Tufton U-5, ATR-2009 and ATR-2010 from Kao Corporation; Eritel UE3500, UE3210, XA-8153, KZA-7049 and KZA-1449 from Unitika Ltd.; polyester-TP-220 and R-188 from The Nippon Synthetic Chemical Industry Co., Ltd.; and thermoplastic resins in the high loss series from SEIKO CHEMICAL INDUSTRIES CO., LTD., and the like.

(c) Polyurethane resins, and the like.

(d) Polyamide resins, urea resins, and the like.

(e) Polysulfone resins, and the like.

(f) Polyvinyl chloride resin, polyvinylidence chloride resin, vinyl chloride-vinyl acetate-copolymer resin, vinyl chloride-vinyl propionate copolymer resin, and the like.

(g) Polyol resins such as polyvinyl butyral, and cellulose resins such as ethyl cellulose resin and cellulose acetate resin.

(h) Polycaprolactone resin, styrene-maleic anhydride resin, polyacrylonitrile resin, polyether resins, epoxy resins, phenol resins, and the like.

One of the thermoplastic resins may be used either alone or in combination of two or more.

A thickness of the thermoplastic resin layer is preferably 5 μm to 100 μm, and more preferably 15 μm to 50 μm. A thermoplastic resin layer disposed on a surface of paper (raw paper, or the like) and a thermoplastic resin layer disposed on a back surface of the paper may have either the same or different components, physical properties, thickness, and structure.

—Laminated Paper—

The aforesaid laminated paper can be formed by laminating various kinds of resins, rubber, polymer sheets or films (may be referred to as laminating materials) on a sheet such as raw paper. Examples of the laminating materials include polyolefin, polyvinyl chloride, polyethylene terephthalate, polystyrene, polymethacrylate, polycarbonate, polyimide, triacetyl cellulose, and the like. These resins may be used alone, or in combination of two or more.

[Supports Coated with a Polyolefin Resin Layer on Both Surfaces]

In the present invention, from the viewpoint of improving image quality, the support preferably includes a polyolefin resin layer on both surfaces of the raw paper. The support preferably has a toner image-receiving layer on at least one surface thereof.

It is preferred, from the viewpoint of improving transport properties during calendering treatment, that the ten point average roughness (Rz) of the polyolefin resin layer on the surface on which the toner image-receiving layer is not to be disposed, is 2 μm to 10 μm, and that the centerline average roughness (Ra) is 0.5 μm to 1.5 μm.

Herein, the ten point average roughness (Rz) and the centerline average roughness (Ra) can be measured according to JIS B0601.

The aforesaid polyolefin resin layer is normally formed of a polyolefin resin such as a homopolymer of an α-olefin like polyethylene, polypropylene or the like, a mixture thereof, or the like. As long as extrusion coating is possible, there is no particular limitation on the molecular weight of the polyolefin resin. However, a polyolefin resin having a molecular weight of 20,000 to 200,000 is normally used.

Examples of the polyethylene resins include high density polyethylene (HDPE), low density polyethylene (LDPE), linear low density polyethylene (L-LDPE) and the like. From the viewpoint of obtaining a uniform and neat cutting section when cut to a specified size by a cutter or the like in a cutting step, the polyethylene resin is preferably a polyethylene resin mixture which contains 40 parts by mass to 75 parts by mass of high density polyethylene and 25 parts by mass to 60 parts by mass of low density polyethylene. Here, the high density polyethylene has the melt index of 5 g/10 min to 30 g/10 min, and preferably 10 g/10 min to 20 g/10 min, and also has the density of 0.945 g/cm³ or more. The low density polyethylene has the melt index of 1 g/10 min to 15 g/10 min, and preferably 2 g/10 min to 10 g/10 min, and also has the density of 0.930 g/cm³ or less. These resins may be used alone, or in combination of two or more.

The mixing ratio of the aforesaid high density polyethylene and the low density polyethylene (HDPE/LDPE) is preferably 40 to 75/60 to 25, and more preferably 50 to 70/50 to 30 in mass ratio. An electrophotographic image-receiving sheet that has a polyolefine resin layer containing 75 parts by mass or more of the high density polyethylene and less than 25 parts by mass of the low density polyethylene, does not exhibits sufficient cutting properties (uniform cut section) in the cutting step. On the other hand, an electrophotographic image-receiving sheet that has a polyorefine resin layer containing less than 40 parts by mass of the high density polyethylene and 60 parts by mass or more of the low density polyethylene, still exhibits sufficient cutting properties (uniform cut section) in the cutting step, however, the surface of the polyolefine resin layer partially melts due to the heating roller during fixing and surface properties are impaired, or jamming occurs due to paper transport failures, which is undesirable.

When the polyolefin resin layer is disposed on both surfaces of the support of the electrophotographic image-receiving sheet, it is preferred to apply a polyolefin resin layer which is formed of a polyethylene mixture having the aforesaid composition to both of the surfaces. The polyolefin resin layer may further contain an interface surfactant to control surface electrical resistance, or an antistatic agent such as a metal oxide, or the like. The polyolefin resin layer which contains the interface surfactant or the antistatic agent may be used as a layer having the additional function of an electroconductive layer.

According to the present invention, from the viewpoint of obtaining good image quality, an inorganic pigment such as titanium dioxide or the like, a bluing agent, a fluorescence brightener, an antioxidant, or the like can be contained in the polyolefine resin layer when having a single layer structure. The above-listed inorganic pigments, the bluing agent, or the like can be contained in at least one of the layers of the polyolefine resin layer when having a multi layer structure. Of these, the titanium oxide is preferred. Here, the polyolefin resin layer refers to the one disposed on a surface of the support on which the toner image-receiving layer is to be disposed.

When the polyolefin resin layer has a multi-layer structure, a viscosity imparting resin, an adhesive resin, or the like can be contained in the lowermost layer of the polyolefine resin layer which contacts the raw paper, from the viewpoint of improving contact properties with the raw paper. The polyolefine resin layer may suitably further contain an antioxidant, peeling agent, hollow polymer, or the like, if necessary.

When the polyolefin resin layer contains titanium dioxide, the titanium dioxide may be anatase or rutyl form. If whiteness is emphasized, the anatase form is preferred. If definitiveness is emphasized, the rutyl form is preferred. If it is desired to impart both whiteness and definitiveness, the anatase form and rutyl form may be blended together, or two polyolefin resin layers which contain titanium oxide may be disposed, in which one of the polyolefin resin layers contains the anatase form and the other contains the rutyl form.

The average particle diameter of the titanium dioxide is preferably 0.1 μm to 0.4 μm. If the average particle size of the titanium dioxide is less than 0.1 μm, it is difficult to disperse uniformly in the polyolefin resin layer. If the average particle diameter is more than 0.4 μm, sufficient whiteness is not obtained, projections appear on the surface of the polyolefin resin layer, and there is an adverse effect on image quality.

The particle surface of the titanium dioxide may be treated with a silane coupling agent. It is preferred that the ends of this silane coupling agent are ethoxy-modified or methoxy-modified. The amount of the silane coupling agent is preferably 0.05% by mass to 2.5% by mass, and more preferably 0.5% by mass to 2.0% by mass, relative to the titanium dioxide. If the amount is less than 0.05% by mass, the surface treatment effect due to the silane coupling agent may be insufficient. If the amount is more than 2.5% by mass, the amount is excessive to be treated, relative to titanium dioxide.

The surface of the titanium dioxide is preferably treated with an inorganic surface treatment agent prior to performing the silane coupling agent surface treatment, in order to control the activity of the titanium dioxide pigment. The inorganic surface treatment agent may preferably be at least one of Al₂O₃ and SiO₂. The amount of the inorganic surface treatment agent (calculated as the anhydride form) is preferably 0.01 by mass to 1.8% by mass, and more preferably 0.2 by mass to 1.0% by mass, relative to the titanium dioxide.

If the titanium dioxide surface is not treated with the inorganic surface treatment agent, the heat resistance of the titanium dioxide is low. In addition, if it is used in an extruded laminate around 320° C., there is a possibility that the titanium dioxide may turn yellow. Furthermore, as the activity of the titanium dioxide is not controlled, the titanium dioxide particles becomes aggregated. Moreover, the aggregated titanium dioxide particles, and there is a risk that the titanium dioxide particles will remain on the metal filter having 20 to 400 mesh, which is generally provided in order to prevent extrusion of foreign matters in the vicinity of the extrusion laminate outlet, and lead to a rise in pressure inside the extruder.

On the other hand, if the treatment amount of the inorganic surface treatment agent relative to titanium dioxide is 1.8% by mass or more, water is more likely to adhere to the surface of the inorganic surface treatment agent. In addition, if it is then used in an extruded laminate, die lip contamination grows vividly faster.

The titanium dioxide is used in combination with a dispersion assistant such as a metal salt of a higher fatty acid, ethyl derivative of the higher fatty acid, higher fatty acid amide, higher fatty acid or polyolefin wax, and is kneaded and mixed in the resin by a kneading device such as a two roller, three roller, kneader, Banbury mixer, continuous kneader, or the like. The dispersion assistant is preferably a metal salt of stearic acid, and more preferably lead stearate. The resin in which the titanium dioxide is kneaded and mixed is formed into pellets and used as a titanium dioxide pigment master batch.

The titanium dioxide concentration in the pellets is preferably around 30% by mass to 75% by mass. The concentration of the dispersion assistant in the pellets is preferably around 0.5% by mass to 10% by mass. If the titanium dioxide concentration is less than 30% by mass, the bulk of the pellets increases. If the titanium dioxide concentration is more than 75% by mass, the dispersion of the titanium dioxide is poor and cracks more likely to appear in the pellets. The master batch which contains titanium dioxide is preferably dried or vacuum dried at 50° C. to 90° C. for two hours or more, prior to usage.

The titanium dioxide content of the polyolefin resin layer is preferably 5% by mass to 50% by mass, and more preferably 8% by mass to 45% by mass. If the titanium dioxide content is less than 5% by mass, resolution deteriorates. If the titanium dioxide content is more than 50% by mass, die lines may appear during manufacture of the electrophotographic image-receiving sheet.

Examples of the bluing agent include a generally known ultramarine, cobalt blue, cobalt oxyphosphoric acid, quinacridine pigment, a mixture thereof, and the like. There is no particular limitation on the particle size of the bluing agent. The particle size of the bluing agent is normally preferred to be 0.3 μm to 10 μm. When the bluing agent is used in the uppermost layer of the polyolefin resin layer, the uppermost layer preferably contains 0.2% by mass to 0.4% by mass. When the bluing agent is used in the lowermost layer, the lowermost layer preferably contains 0% by mass to 0.15% by mass of the bluing agent.

The amount of the antioxidant in the aforesaid polyolefin resin layer is preferably around 50 ppm to 1,000 ppm, relative to the resin forming the polyolefin resin layer. The master batch which contains the titanium dioxide pigment manufactured in this way is suitably diluted using the resin which forms the polyolefin resin layer, and used for the extruded laminate.

The viscosity imparting agent resin may be suitably selected from a rosin derivative resin, a terpene resin (e.g., polymer β-pinene), a cumarone-indene resin, a petroleum hydrocarbon resin, or the like. These resins may be used alone, or in combination of two or more.

Examples of petroleum hydrocarbon resins include an aliphatic petroleum resin, an aromatic petroleum resin, a dicyclopentadiene petroleum resin, a copolymer petroleum resin, a hydrated petroleum resin, an aliphatic petroleum resin, and the like. The aliphatic petroleum resin preferably has 5 carbon atoms. The aromatic petroleum resin preferably has 9 carbon atoms.

The amount of viscosity imparting agent resin is preferably 0.5% by mass to 60% by mass, and more preferably 10% by mass to 35% by mass, relative to the resin forming the polyolefin resin layer. If the amount of viscosity imparting agent resin is less than 0.5% by mass, adhesion may be poor. If the amount is more than 60% by mass, neck in during manufacture of the electrophotographic image-receiving sheet easily occurs.

Examples of the adhesive resin include an ionomer, ethylene vinyl acetate copolymer (EVA), ethylene-acrylic acid copolymer, metal salt thereof, and the like. The blending amount of the adhesive resin is normally preferably 20 parts by mass to 500 parts by mass, and more preferably 50 parts by mass to 200 parts by mass, relative to the resin forming the polyolefin resin layer. The viscosity imparting agent resin and the adhesive resin may be used in combination.

The aforesaid polyolefin resin layer may be formed by melting pellets which contain the heated and melted titanium dioxide. If necessary, the pellets are diluted with a resin which constitutes the polyolefin resin layer, and are melted. Thereafter, the pellets are coated onto the aforesaid raw paper during transporting, by ordinary lamination, sequential lamination, or a lamination method using a single layer or multi-layer extrusion die or laminator such as the heat block type, multi-manifold type, multi-slot type, or the like. The aforesaid polyolefin resin layer may be hence formed. There is no particular limitation on the shape of the single layer or multi-layer extrusion die. Examples of the single-layer or multi-layer extrusion die include a T-die or coat hanger die, and the like.

According to the present invention, before coating the resin forming the polyolefin resin layer onto one or both surfaces of the raw paper, it is preferred to give an activation treatment to the raw paper such as corona discharge treatment, flame treatment, glow discharge treatment, plasma treatment, or the like.

The thickness of the polyolefin resin layer to be formed on a surface of the support on which the toner image-receiving layer is to be disposed, is preferably 10 μm to 60 μm. The thickness of the polyolefin resin layer formed on the surface on which the toner image-receiving layer is not to be disposed (back surface of the support) is preferably 10 μm to 50 μm.

A surface of the uppermost layer of the polyolefin resin layer, which is formed on a surface of the support on which the toner image-receiving layer is to be disposed, is subjected to glossy finish, or a fine finish, matt finish or silk finish as disclosed in JP-A No. 55-26507. A surface of the lowermost layer of the polyolefin resin layer, which is formed on a surface of the support on which the toner image-receiving layer is not to be disposed, is subjected to non-glossy finish. After the finish, both of the surfaces may be given an activation treatment such as corona discharge treatment, flame treatment, or the like. An under coating treatment can be additionally provided in accordance with the known methods in the arts after activation treatment.

There is no particular limitation on the method of mixing the high density polyethylene and the low density polyethylene in the polyethylene mixture used for the polyolefin resin layer, and any desired method can be used. For example, a predetermined amount of the high density polyethylene and the low density polyethylene, together with various additives if necessary, may be melted and mixed using for example a kneading extruder, heat kneading roller, Banbury mixer, kneader, or the like. The mixture may be pulverized or made into pellets, or these components may easily be directly introduced in the blending state to an extruder, and extrusion coated.

The thickness of the support is preferably 25 μm to 300 μm, more preferably 50 μm to 260 μm, and still more preferably 75 μm to 220 μm. The rigidity of the support may vary according to the purpose. It is preferred that the support used for the electrophotographic image-receiving sheet which gives photographic image quality are close to those used for color silver halide photography.

[Toner Image-Receiving Layer]

The above-mentioned toner image-receiving layer receives a color or black toner and forms an image. The toner image-receiving layer has a function to receive toner which forms an image from a developing drum or an intermediate transfer by (static) electricity or pressure in a transferring step, and to fix the image by heat or pressure in a fixing step.

In the toner image-receiving layer, the thermoplastic resin contained in the toner image-receiving layer is preferably penetrated into a predetermined depth of the support. The depth to which the thermoplastic resin is penetrated, is preferably 1/100 or more, and more preferably ½ or more, of the thickness of the support measured from the surface of the support. If the thermoplastic resin is penetrated within this range, there is no blistering between the support and the toner image-receiving layer, and an electrophotographic image-receiving sheet which gives a clear toner image can be stably provided. In this case, the thermoplastic resin contained in the toner image-receiving layer may have a concentration gradient, or it may be penetrated in a constant, uniform or non-uniform state in the depth relative to the thickness of the support.

When the thermoplastic resin forming the toner image-receiving layer is for example adjacent to the surface of the support and penetrates into the support to the depth of, for example, less than 1/100, and preferably less than 1/500 of the thickness of the support from the surface, the glossiness of the electrophotographic image-receiving sheet obtained is still further enhanced, which is desirable. In this case also, the thermoplastic resin forming the toner image-receiving layer may have a concentration gradient, or it may be penetrated in a constant, uniform or non-uniform state in the depth relative to the thickness of the support.

The thermoplastic resin forming the toner image-receiving layer may be introduced to this predetermined depth by, for example, applying a coating solution forming the toner image-receiving layer on the surface of the support, and drying. However, the properties of the coating solution must be considered according to the depth to which the thermoplastic resin is to be penetrated. For example, if it is desired to allow the thermoplastic resin to penetrate to a deeper position, the viscosity of the coating solution is for example 30 mPa·s or more, and preferably 60 mPa·s or more. Also, the surface tension of the coating solution is for example preferably 50 mN/m or less, and more preferably 35 mN/m or less.

In other words, by making adjustments to obtain the above viscosity and physical properties in view of the type and physical properties of the thermoplastic resin forming the coating solution, and if necessary any desired additives, the thermoplastic resin forming the toner image-receiving layer can be penetrated to a predetermined depth in the raw paper (which serves as the support) in a continuous state from the toner image-receiving layer.

After application, the coating solution is dried for two minutes, preferably one minute and more preferably 30 seconds. The end point of drying may for example be the point at which the temperature of the coated surface becomes same as the wet-bulb temperature of the drying atmosphere.

The toner image-receiving layer may contain various additives in addition to the thermoplastic resin, to the extent that it does not lose its function as a toner image-receiving layer.

—Thermoplastic Resin—

The thermoplastic resin can be any types of resin as long as it becomes deformed and is able to receive toners at fixing temperature. The thermoplastic resin in the toner image-receiving layer is preferably the same type of a resin as the one used in a binder for the toner. Examples of the resin used in a binder for the toner include a polyester resin, styrene-acrylate copolymer, styrene-methacrylate copolymer, and the like. Therefore, the thermoplastic resin in the toner image-receiving layer are also preferably a thermoplastic resin such as a polyester resin, styrene-acrylate copolymer, styrene-methacrylate copolymer, or the like.

The following are examples of the thermoplastic resin.
(a) Thermoplastic resins containing an ester bond

Polyester resins obtained by condensation of a dicarboxylic acid component and an alcoholic component, polyacrylate resins or polymethacrylate resins such as polymethylmethacrylate, polybutylmethacrylate, polymethylacrylate, polybutyl acrylate, or the like; polycarbonate resins, polyvinyl acetate resins, styrene acrylate resins, styrene-methacrylate copolymer resins, vinyltoluene acrylate resins, or the like.

Specific examples of the dicarboxylic acid component include terephthalic acid, isophthalic acid, maleic acid, fumaric acid, phthalic acid, adipic acid, sebacic acid, azelaic acid, abietic acid, succinic acid, trimellitic acid, pyromellitic acid, and the like. These may be substituted by a sulfonic acid group, carboxyl group, or the like. Specific examples of the alcoholic component include ethylene glycol, diethylene glycol, propylene glycol, bisphenol A, diether derivative of bisphenol A (for example, ethylene oxide diadduct of bisphenol A, propylene oxide diadduct of bisphenol A) or bisphenol S, 2-ethyl cyclohexyldimethanol, neopentyl glycol, dicyclohexyldimethanol or glycerol. These may be substituted by hydroxyl groups.

Examples can also be found in JP-A No. 59-101395, No. 63-7971, No. 63-7972, No. 63-7973 and No. 60-294862. Commercial products that may be used include Byron 290, Byron 200, Byron 280, Byron 300, Byron 103, Byron GK-140 and Byron GK-130 from Toyobo Co., Ltd., Tufton NE-382, Tufton U-5, ATR-2009 and ATR-2010 from Kao Corporation, Eritel UE3500, UE3210 and XA-8153 from Unitika Ltd., Polystar TP-220, R-188 from Nippon Synthetic Chemical Industry Co., Ltd., and the like.
(b) Polyolefin resins such as polyethylene resin and polypropylene resin, copolymer resins of olefins such as ethylene and propylene with other vinyl monomers, and acrylic resins, and the like.
(c) Polyurethane resin and the like.
(d) Polyamide resin, urea resin, and the like.
(e) Polysulfone resin, and the like.
(f) Polyvinyl chloride resin, polyvinylidene chloride resin, vinyl chloride-vinyl acetate copolymer resin, vinyl chloride-vinyl propionate copolymer resin, and the like.
(g) Polyol resins such as polyvinylbutyral, cellulosic resins such as ethyl cellulose resin and cellulose acetate resin, and the like.
(h) Polycaprolactone resin, styrene-maleic anhydride resin, polyacrylonitrile resin, polyether resin, epoxy resin, phenol resin, and the like.

It is preferred that the thermoplastic resin satisfies the physical properties disclosed in JP-A No. 05-127413, JP-A Nos. 08-194394, 08-334915, 08-334916, 09-171265, 10-221877, and the like.

The thermoplastic resin preferably satisfies the physical properties disclosed above when contained in the toner image-receiving layer. The thermoplastic resin preferably satisfies the physical properties alone. The thermoplastic resins above can be used in combination of two or more, each of which has different physical properties.

It is preferred that the thermoplastic resin has a larger molecular weight than that of the thermoplastic resin used for the toner. However, this molecular weight relation may not always be desirable depending on the thermodynamic properties of the thermoplastic resin used for the toner and the resin used for the toner image-receiving layer. For example, if the softening point of the resin used for the toner image-receiving layer is higher than that of the thermoplastic resin used for the toner, it is preferred that the molecular weights are identical, or that the molecular weight of the resin used for the toner image-receiving layer is smaller.

It is preferred that the thermoplastic resin used is a mixture of resins with identical compositions having different average molecular weights. The preferable relation of molecular weights of thermoplastic resins used as toners is disclosed in JP-A No. 08-334915.

The molecular weight distribution of the thermoplastic resin is preferably wider than the molecular weight distribution of the thermoplastic resin used in the toner.

The thermoplastic resin is preferably suitable for a coating solution. The thermoplastic resin can be one of water-soluble and water-dispersible, as long as it can be used for a coating solution.

As long as being water-soluble, the thermoplastic resin may have any composition, bond structure, molecular structure, molecular weight, molecular weight distribution or formation. In order to give the thermoplastic resin water-solubility, the thermoplastic resin is required to have a water-soluble group. Examples of the water-soluble group include a hydroxyl group, a carboxyl group, an amino group, an amide group, an ether group, and the like.

Examples of the water-soluble resins are given on page 26 of Research Disclosure No. 17,643, page 651 of Research Disclosure No. 18,716, pp. 873-874 of Research Disclosure No. 307,105 and pp. 71-75 of JP-A No. 64-13546. Specific examples the water-soluble resins include a vinyl pyrrolidone-vinyl acetate copolymer, styrene-vinyl pyrrolidone copolymer, styrene-maleic anhydride copolymer, water-soluble polyester, water-soluble acryl, water-soluble polyurethane, water-soluble nylon, a water-soluble epoxy resin, and the like.

Examples of the water-dispersible resins include acrylic resin emulsion, polyvinyl acetate emulsion, SBR (styrene butadiene rubber) emulsion, polyester resin emulsion, polystyrene resin emulsion, urethane resin emulsion, and the like. These can be used in combination of two ore more. When the water-dispersible thermoplastic resin is gelatin, the gelatin can be selected from deliming gelatin such as lime gelatin, acid treatment gelatin, or the like, in which the content of calcium is reduced, according to object.

When the binder of the toners is a polyester resin, the polyester resin is preferably used in the toner image-receiving layer.

Examples of commercial products of the polyester resins include Bailon 290, Bailon 200, Bailon 280, Bailon 300, Bailon 103, Bailon GK-140 and Bailon GK-130 from Toyobo Co., Ltd; Tufton NE-382, Tufton U-5, ATR-2009 and ATR-2010 from Kao Corporation; Eritel UE3500, UE3210, XA-8153, KZA-7049 from Unitika Ltd.; Polyester TP-220 and R-188 from The Nippon Synthetic Chemical Industry Co., Ltd., and the like.

Examples of commercial products of the above-mentioned acrylic resins include SE-5437, SE-5102, SE-5377, SE-5649, SE-5466, SE-5482, HR-169, HR-124, HR-1127, HR-116, HR-113, HR-148, HR-131, HR-470, HR-634, HR-606, HR-607, LR-1065, LR-574, LR-143, LR-396, LR-637, LR-162, LR-469, LR-216, BR-50, BR-52, BR-60, BR-64, BR-73, BR-75, BR-77, BR-79, BR-80, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 from Mitsubishi Rayon Ltd.; Esrec P SE-0020, SE-0040, SE-0070, SE-0100, SE-1010, SE-1035 from Sekisui Chemical Co., Ltd.; Himer ST95 and ST120 from Sanyo Chemical Industries, Ltd.; and FM601 from Mitsui Chemicals, Inc., and the like.

Examples of commercial products of the polyester emulsion include Vilonal MD-1250, Md-1930, from Toyobo Co., Ltd; Plus coat Z-446, and Z-465 from GaO Chemical Industries; ES-611, ES-670 from DAINIPPON INK AND CHEMICALS, INCORPORATED; Pethregin A-160P, A-210, A-515GB, A-620 from TAKAMATSU OIL& FAT CO., LTD, and the like.

The film-forming temperature of the polymer is preferably room temperature or higher, from the viewpoint of pre-print storage, and preferably 100° C. or lower, from the viewpoint of fixing toners.

It is desirable to use a self-dispersing water-dispersible polyester resin emulsion satisfying the following properties (1) to (4) as the above-mentioned thermoplastic resin in the toner image-receiving layer. As this is a self-dispersing type which does not use a surfactant, its hygroscopicity is low even in a high humidity environment, its softening point is not much reduced by moisture, and offset produced during fixing, or sticking of sheets in storage, can be suppressed. Moreover, since it is aqueous, it is very environment-friendly and has excellent workability. As it uses a polyester resin which easily assumes a molecular structure with high cohesion energy, it has sufficient hardness in a storage environment, assumes a melting state of low elasticity (low viscosity) in the fixing step for electrophotography, and toner is embedded in the toner image-receiving layer so that a sufficiently high image quality is attained.

(1) The number average molecular weight (Mn) is preferably 5000 to 10000, and more preferably 5000 to 7000.

(2) The molecular weight distribution (Mw/Mn) (weight average molecular weight/number average molecular weight) is preferably 4 or less, and more preferably 3 or less.

(3) The glass transition temperature (Tg) is preferably 40° C. to 100° C., and more preferably 50° C. to 80° C.

(4) The volume average particle diameter is preferably 20 nm to 200 nm, and more preferably 40 nm to 150 nm.

A content of the thermoplastic resin in the toner image-receiving layer is preferably 10% by mass or more, and more preferably 30% by mass or more.

Various additives may be oriented to improve the thermodynamic properties of the toner image-receiving layer. Examples of the additives include plasticizers, fillers, crosslinking agents, charge control agents, emulsifiers, dispersants, and the like.

—Plasticizers—

The plasticizers known in the art may be used without any particular limitation. These plasticizers have the effect of adjusting the fluidity or softening of the toner image-receiving layer due to heat and/or pressure.

The plasticizer may be selected by referring to “Chemical Handbook,” (Chemical Institute of Japan, Maruzen), “Plasticizers—their Theory and Application,” (ed. Koichi Murai, Saiwai Shobo), “The Study of Plasticizers, Part 1” and “The Study of Plasticizers, Part 2” (Polymer Chemistry Association), or “Handbook of Rubber and Plastics Blending Agents” (ed. Rubber Digest Co.), or the like.

Some of the plasticizers are listed as high boiling point organic solvents, heat solvents, or the like. Specific examples can be found in JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, 62-174754, 62-245253, 61-209444, 61-200538, 62-8145, 62-9348, 62-30247, 62-136646 and 02-235694, or the like.

The specific examples include compounds of esters (for example, phthalic esters, phosphate esters, aliphatic acid esters, abiethyne acid ester, abietic acid ester, sebacic acid esters, azelinic ester, benzoates, butylates, epoxy aliphatic acid esters, glycolic acid esters, propionic acid esters, trimellitic acid esters, citrates, sulfonates, carboxylates, succinic acid esters, maleates, fumaric acid esters, phthalic acid esters, stearic acid esters, and the like), of amides (for example, aliphatic acid amides and sulfoamides), of ethers, of alcohols, of lactones, of polyethyleneoxy, and the like.

The plasticizers can be mixed into a resin.

The plasticizers may be polymers having relatively low molecular weight. In this case, it is preferred that the molecular weight of the plasticizer is lower than the molecular weight of the binder resin to be plasticized. Preferably, plasticizers have a molecular weight of 15000 or less, or more preferably 5000 or less. When a polymer plasticizer is used as the plasticizer, the polymer of the polymer plasticizer is the same as that of the binder resin to be plasticized. For example, when the polyester resin is plasticized, polyester having low molecular weight is preferable. Further, oligomers may also be used as plasticizers. Apart from the compounds mentioned above, there are commercially products such as, for example, Adecasizer PN-170 and PN-1430 from Asahi Denka Co., Ltd.; PARAPLEX-G-25, G-30 and G-40 from C. P. Hall; and, rosin ester 8 L-JA, ester R-95, pentalin 4851, FK 115, 4820, 830, Ruizol 28-JA, Picolastic A75, Picotex LC and Cristalex 3085 from Rika Hercules, Inc, and the like.

The plasticizer can be used as desired to relax stress and distortion (physical distortions of elasticity and viscosity, and distortions of mass balance in molecules, binder main chains or pendant portions) which are produced when toners are embedded in the toner image-receiving layer.

The plasticizer may be dispersed in micro in the toner image-receiving layer. The plasticizer may also be dispersed in micro in a state of sea-island, in the toner image-receiving layer. The plasticizer may present in the toner image-receiving layer in a state of sufficiently mixed with other components such as binder or the like.

The content of plasticizer in the toner image-receiving layer is preferably 0.001% by mass to 90% by mass, more preferably 0.1% by mass to 60% by mass, and still more preferably 1% by mass to 40% by mass.

The plasticizer may be used for the purposes of adjusting slip properties (improved transportability due to decrease in friction), improving offset at a fixing part (separation of toner or layers onto the fixing part), adjusting curl balance or adjusting charge (forming a toner electrostatic image).

—Releasing Agent—

The releasing agent can be blended to the toner image-receiving layer in order to prevent offset of the toner image-receiving layer. Various types of the releasing agent can be used as long as it is able to form a layer of the releasing agent on a surface of the toner image-receiving layer by being heated and melted so as to deposit and to remain on the surface of the toner image-receiving layer, and by being cooled and solidified so as to form a layer of the releasing agent, thereafter.

The releasing agent is at least one or more releasing agents selected from silicone compounds, fluorine compounds, wax, and matting agents. Preferably, it is at least one or more releasing agents selected from silicone oil, polyethylene wax, carnauba wax, silicone particles and polyethylene wax particles.

The releasing agent may for example be a compound mentioned in “Properties and Applications of Wax (Revised)” by Saiwai Publishing, or in the Silicone Handbook published by THE NIKKAN KOGYO SHIMBUN. Also, the silicone compounds, fluorine compounds and wax in the toners mentioned in Japanese Patent Application Publication (JP-B) No. 59-38581, Japanese Patent Application Publication (JP-B) No. 04-32380, Japanese Patent (JP-B) No. 2838498, Japanese Patent (JP-B) No. 2949558, Japanese Patent Application Laid-Open (JP-A) No. 50-117433, No. 52-52640, No. 57-148755, No. 61-62056, No. 61-62057, No. 61-118760, and Japanese Patent Application Laid-Open (JP-A) No. 0242451, No. 03-41465, No. 04-212175, No. 04-214570, No. 04-263267, No. 05-34966, No. 05-119514, No. 06-59502, No. 06-161150, No. 06-175396, No. 06-219040, No. 06-230600, No. 06-295093, No. 07-36210, No. 0743940, No. 07-56387, No. 07-56390, No. 07-64335, No. 07-199681, No. 07-223362, No. 07-287413, No. 08-184992, No. 08-227180, No. 08-248671, No. 08-248799, No. 08-248801, No. 08-278663, No. 09-152739, No. 09-160278, No. 09-185181, No. 09-319139, No. 09-319143, No. 10-20549, No. 10-48889, No. 10-198069, No. 10-207116, No. 11-2917, No. 11-44969, No. 11-65156, No. 11-73049 and No. 11-194542 may be used. These compounds can also be used in combination of two or more.

Examples of the silicone compounds include non-modified silicone oils (specifically, dimethyl siloxane oil, methyl hydrogen silicone oil, phenyl methyl-silicone oil, or commercial products such as KF-96, KF-96L, KF-96H, KF-99, KF-50, KF-54, KF-56, KF-965, KF-968, KF-994, KF-995 and HIVAC F-4, F-5 from Shin-Etsu Chemical Co., Ltd.; SH200, SH203, SH490, SH510, SH550, SH710, SH704, SH705, SH7028A, SH7036, SM7060, SM7001, SM7706, SH7036, SH8710, SH1107 and SH8627 from Dow Corning Toray Silicone Co., Ltd.; and TSF400, TSF401, TSF404, TSF405, TSF431, TSF433, TSF434, TSF437, TSF450 series, TSF451 series, TSF456, TSF458 series, TSF483, TSF484, TSF4045, TSF4300, TSF4600, YF33 series, YF-3057, YF-3800, YF-3802, YF-3804, YF-3807, YF-3897, XF-3905, XS69-A1753, TEX100, TEX101, TEX102, TEX103, TEX104, TSW831, and the like from GE Toshiba Silicones), amino-modified silicone oils (for example, KF-857, KF-858, KF-859, KF-861, KF-864 and KF-880 from Shin-Etsu Chemical Co., Ltd., SF8417 and SM8709 from Dow Corning Toray Silicone Co., Ltd., and TSF4700, TSF4701, TSF4702, TSF4703, TSF4704, TSF4705, TSF4706, TEX150, TEX151 and TEX154 from GE Toshiba Silicones), carboxy-modified silicone oils (for example, BY16-880 from Dow Corning Toray Silicone Co., Ltd., TSF4770 and XF42-A9248 from GE Toshiba Silicones), carbinol-modified silicone oils (for example, XF42-B0970 from GE Toshiba Silicones), vinyl-modified silicone oils (for example, XF40-A1987 from GE Toshiba Silicones), epoxy-modified silicone oils (for example, SF8411 and SF8413 from Dow Corning Toray Silicone Co., Ltd.; TSF3965, TSF4730, TSF4732, XF42-A4439, XF42-A4438, XF42-A5041, XC96-A4462, XC96-A4463, XC96-A4464 and TEX170 from GE Toshiba Silicones), polyether-modified silicone oils (for example, KF-351 (A), KF-352 (A), KF-353 (A), KF-354 (A), KF-355 (A), KF-615(A), KF-618 and KF-945 (A) from Shin-Etsu Chemical Co., Ltd.; SH3746, SH3771, SF8421, SF8419, SH8400 and SF8410 from Dow Corning Toray Silicone Co., Ltd.; TSF4440, TSF4441, TSF4445, TSF4446, TSF4450, TSF4452, TSF4453 and TSF4460 from GE Toshiba Silicones), silanol-modified silicone oils, methacryl-modified silicone oil, mercapto-modified silicone oil, alcohol-modified silicone oil (for example, SF8427 and SF8428 from Dow Corning Toray Silicone Co., Ltd., TSF4750, TSF4751 and XF42-B0970 from GE Toshiba Silicones), alkyl-modified silicone oils (for example, SF8416 from Dow Corning Toray Silicone Co., Ltd., TSF410, TSF411, TSF4420, TSF4421, TSF4422, TSF4450, XF42-334, XF42-A3160 and XF42-A3161 from GE Toshiba Silicones), fluorine-modified silicone oils (for example, FS1265 from Dow Corning Toray Silicone Co., Ltd., and FQF501 from GE Toshiba Silicones), silicone rubbers and silicone fine particles (for example, SH851, SH745U, SH55UA, SE4705U, SH502 UA&B, SRX539U, SE6770 U-P, DY38-038, DY38-047, Trefil F-201, F-202, F-250, R-900, R-902A, E-500, E-600, E-601, E-506, BY29-119 from Dow Corning Toray Silicone Co., Ltd.; Tospal 105, Tospal 120, Tospal 130, Tospal 145, Tospal 240 and Tospal 3120 from GE Toshiba Silicones), silicone-modified resins (specifically, olefin resins, polyester resins, vinyl resins, polyamide resins, cellulosic resins, phenoxy resins, vinyl chloride-vinyl acetate resins, urethane resins, acrylic resins, styrene-acrylic resins, compounds in which copolymerization resins thereof are modified by silicone, and the like), and the like. Examples of the commercial products include Diaroma SP203V, SP712, SP2105 and SP3023 from Dainichiseika Color & Chemicals Mfg. Co., Ltd.; Modepa FS700, FS710, FS720, FS730 and FS770 from NOF CORPORATION; Simac US-270, US-350, US-352, US-380, US-413, US-450, Reseda GP-705, GS-30, GF-150 and GF-300 from TOAGOSEI CO., LTD.; SH997, SR2114, SH2104, SR2115, SR2202, DCI-2577, SR2317, SE4001U, SRX625B, SRX643, SRX439U, SRX488U, SH804, SH840, SR2107 and SR2115 from Dow Coming Toray Silicone Co., Ltd., YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TEX153, TEX171 and TEX172 from GE Toshiba Silicones), and reactive silicone compounds (specifically, addition reaction type, peroxide-curing type and ultraviolet radiation curing type, examples thereof include: TSR1500, TSR1510, TSR1511, TSR1515, TSR1520, YR3286, YR3340, PSA6574, TPR6500, TPR6501, TPR6600, TPR6702, TPR6604, TPR6700, TPR6701, TPR6705, TPR6707, TPR6708, TPR6710, TPR6712, TPR6721, TPR6722, UV9300, UV9315, UV9425, UV9430, XS56-A2775, XS56-A2982, XS56-A3075, XS56-A3969, XS56-A5730, XS56-A8012, XS56-B1794, SL6100, SM3000, SM3030, SM3200 and YSR3022 from GE Toshiba Silicones), and the like.

Examples of the fluorine compounds include fluorine oils (for example, Daifluoryl #1, Daifluoryl #3, Daifluoryl #10, Daifluoryl #20, Daifluoryl #50, Daifluoryl #100, Unidyne TG-440, TG-452, TG-490, TG-560, TG-561, TG-590, TG-652, TG-670U, TG-991, TG-999, TG-3010, TG-3020 and TG-3510 from Daikin Industries, Ltd.; MF-100, MF-110, MF-120, MF-130, MF-160 and MF-160E from Tohkem Products; S-111, S-112, S-113, S-121, S-131, S-132, S-141 and S-145 from Asahi Glass Co., Ltd.; and, FC-430 and FC-431 from DU PONT-MITSUI FLUOROCHEMICALS COMPANY, LTD.), fluoro rubbers (for example, LS63U from Dow Corning Toray Silicone Co., Ltd.), fluorine-modified resins (for example, Modepa F200, F220, F600, F220, F600, F2020, F3035 from Nippon Oils and Fats; Diaroma FF203 and FF204 from Dai Nichi Pure Chemicals; Saflon S-381, S-383, S-393, SC-101, SC-105, KH-40 and SA-100 from Asahi Glass Co., Ltd.; EF-351, EF-352, EF-801, EF-802, EF-601, TFE, TFEA, TFEMA and PDFOH from Tohkem Products; and THV-200P from Sumitomo 3M), fluorine sulfonic acid compound (for example, EF-101, EF-102, EF-103, EF-104, EF-105, EF-112, EF-121, EF-122A, EF-122B, EF-122C, EF-123A, EF-123B, EF-125M, EF-132, EF-135M, EF-305, FBSA, KFBS and LFBS from Tohkem Products), fluorosulfonic acid, and fluorine acid compounds or salts (specifically, anhydrous fluoric acid, dilute fluoric acid, fluoroboric acid, zinc fluoroborate, nickel fluoroborate, tin fluoroborate, lead fluoroborate, copper fluoroborate, fluorosilicic acid, fluorinated potassium titanate, perfluorocaprylic acid, ammonium perfluorooctanoate, and the like), inorganic fluorides (specifically, aluminum fluoride, potassium fluoride, fluorinated potassium zirconate, fluorinated zinc tetrahydrate, calcium fluoride, lithium fluoride, barium fluoride, tin fluoride, potassium fluoride, acid potassium fluoride, magnesium fluoride, fluorinated titanic acid, fluorinated zirconic acid, ammonium hexafluorinated phosphoric acid, potassium hexafluorinated phosphoric acid, and the like).

Examples of the wax include synthetic hydrocarbon, modified wax, hydrogenated wax, natural wax, and the like.

Examples of the synthetic hydrocarbon include polyethylene wax (for example, polyron A, 393, and H-481 from Chukyo Yushi Co., Ltd.; Sunwax E-310, E-330, E-250P, LEL-250, LEL-800, LEL-400P, from SANYO KASEI Co., Ltd.), polypropyrene wax (for example, biscoal 330-P, 550-P, 660-P from SANYO KASEI Co., Ltd.), Fischer toropush wax (for example, FT100, and FT-0070, from Nippon Seiro Co., Ltd.), an acid amide compound or an acid imide compound (specifically, stearic acid amide, anhydrous phthalic acid imide, or the like; for example, Cellusol 920, B-495, hymicron G-270, G-110, hydrine D-757 from Chukyo Yushi Co., Ltd.), and the like.

Examples of the modified wax include amine-modified polypropyrene (for example, QN-7700 from SANYO KASEI Co., Ltd.), acrylic acid-modified wax, fluorine-modified wax, olefin-modified wax, urethane wax (for example, NPS-6010, and HAD-5090 from Nippon Seiro Co., Ltd.), alcohol wax (for example, NPS-9210, NPS-9215, OX-1949, XO-020T from Nippon Seiro Co., Ltd.), and the like.

Examples of the hydrogenated wax include cured castor oil (for example, castor wax from Itoh Oil Chemicals Co., Ltd.), castor oil derivatives (for example, dehydrated castor oil DCO, DCO Z-1, DCO Z-3, castor oil aliphatic acid CO-FA, ricinoleic acid, dehydrated castor oil aliphatic acid DCO-FA, dehydrated castor oil aliphatic acid epoxy ester D-4 ester, castor oil urethane acrylate CA-10, CA-20, CA-30, castor oil derivative MINERASOL S-74, S-80, S-203, S-42X, S-321, special castor oil condensation aliphatic acid MINERASOL RC-2, RC-17, RC-55, RC-335, special castor oil condensation aliphatic acid ester MINERASOL LB-601, LB-603, LB-604, LB-702, LB-703, #11 and L-164 from Itoh Oil Chemicals Co., Ltd.), stearic acid (for example, 12-hydroxystearic acid from Itoh Oil Chemicals Co., Ltd.), lauric acid, myristic acid, palmitic acid, behenic acid, sebacic acid (for example, sebacic acid from Itoh Oil Chemicals Co., Ltd.), undecylenic acid (for example, undecylenic acid from Itoh Oil Chemicals Co., Ltd.), heptyl acids (heptyl acids from Itoh Oil Chemicals Co., Ltd.), maleic acid, high grade maleic oils (for example, HIMALEIN DC-15, LN-10, LN-00-15, DF-20 and SF-20 from Itoh Oil Chemicals Co., Ltd.), blown oils (for example, selbonol #10, #30, #60, R-40 and S-7 from Itoh Oil Chemicals Co., Ltd.), synthetic wax such as cyclopentadieneic oil (CP oil and CP oil-S from Itoh Oil Chemicals Co., Ltd., or the like), and the like.

The natural wax is preferably any wax selected from vegetable wax, animal wax, mineral wax, and petroleum wax.

Examples of the vegetable wax include carnauba wax (for example, EMUSTAR AR-0413 from Nippon Seiro Co., Ltd., and Cellusol 524 from Chukyo Yushi Co., Ltd.), castor oil (purified castor oil from Itoh Oil Chemicals Co., Ltd.), rapeseed oil, soybean oil, Japan tallow, cotton wax, rice wax, sugarcane wax, candellila wax, Japan wax, jojoba oil, and the like. Of these, carnauba wax having a melting point of 70° C. to 95° C. is particularly preferable from viewpoints of providing an electrophotographic image-receiving sheet which is excellent in anti-offset properties, adhesive resistance, paper transporting properties, gloss, is less likely to cause crack and splitting, and is capable of forming a high quality image.

Examples of the animal wax include bees wax, lanolin, spermaceti, whale oil, wool wax, and the like.

Examples of the mineral wax include montan wax, montan ester wax, ozokerite, ceresin, and the like, aliphatic acid esters (Sansosizer-DOA, AN-800, DINA, DIDA, DOZ, DOS, TOTM, TITM, E-PS, nE-PS, E-PO, E-4030, E-6000, E-2000H, E-9000H, TCP, C-1100, and the like, from New Japan Chemical Co., Ltd.), and the like. Of these, montan wax having a melting point of 70° C. to 95° C. is particularly preferable from viewpoints of providing an electrophotographic image-receiving sheet which is excellent in anti-offset properties, adhesive resistance, paper transporting properties, gloss, is less likely to cause crack and splitting, and is capable of forming a high quality image.

Examples of the petroleum wax include paraffin wax (for example, Paraffin wax 155, Paraffin wax 150, Paraffin wax 140, Paraffin wax 135, Paraffin wax 130, Paraffin wax 125, Paraffin wax 120, Paraffin wax 115, HNP-3, HNP-5, HNP-9, HNP-10, HNP-11, HNP-12, HNP-14G, SP-0160, SP-0145, SP-1040, SP-1035, SP-3040, SP-3035, NPS-8070, NPS-L-70, OX-2151, OX-2251, EMUSTAR-0384 and EMUSTAR-0136 from Nippon Oils and Fats Co., Ltd.; Cellosol 686, Cellosol 428, Cellosol 651-A, Cellosol A, H-803, B-460, E-172, E-866, K-133, hydrin D-337 and E-139 from Chukyo Yushi Co., Ltd.; 125° paraffin, 125° FD, 130° paraffin, 135° paraffin, 135° H, 140° paraffin, 140° N, 145° paraffin and paraffin wax M from Nippon Oil Corporation), or a microcrystalline wax (for example, Hi-Mic-2095, Hi-Mic-3090, Hi-Mic-1080, Hi-Mic-1070, Hi-Mic-2065, Hi-Mic-1045, Hi-Mic-2045, EMUSTAR-0001 and EMUSTAR-042X from Nippon Oils and Fats Co., Ltd; Cellosol 967, M, from Chukyo Yushi Co., Ltd.; 155 Microwax and 180 Microwax from Nippon Oil Corporation), and petrolatum (for example, OX-1749, OX-0450, OX-0650B, OX-0153, OX-261BN, OX-0851, OX-0550, OX-0750B, JP-1500, JP-056R and JP-011P from Nippon Oils and Fats Co., Ltd.), and the like.

A content of the natural wax in the toner image-receiving layer (a surface) is preferably 0.1 g/m² to 4 g/m², and more preferably 0.2 g/m² to 2 g/m². If the content is less than 0.1 g/m², the anti-offset properties and the adhesive resistance deteriorate. If the content is more than 4 g/m², the quality of an image may deteriorate because of the excessive amount of wax.

The melting point of the natural wax is preferably 70° C. to 95° C., and more preferably 75° C. to 90° C., from a viewpoint of anti-offset properties and paper transporting properties.

The matting agent can be selected from any known matting agent. Solid particles used as matting agents can be classified into inorganic particles and organic particles. Specifically, the inorganic matting agents may be oxides (for example, silicon dioxide, titanium oxide, magnesium oxide, aluminum oxide), alkaline earth metal salts (for example, barium sulfate, calcium carbonate, and magnesium sulfate), silver halides (for example, silver chloride, and silver bromide), glass, and the like.

Examples of the inorganic matting agents can be found, for example, in West German Patent No. 2529321, the U. K. Patent Nos. 760775, 1260772, and the U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Materials of the organic matting agent include starch, cellulose ester (for example, cellulose-acetate propionate), cellulose ether (for example, ethyl cellulose) and a synthetic resin. It is preferred that the synthetic resin is insoluble or difficult to become solved. Examples of insoluble or difficult to become solved in synthetic resins include poly(meth)acrylic acid esters (for example, polyalkyl(meth)acrylate, polyalkoxyalkyl(meth)acrylate, polyglycidyl(meth)acrylate), poly(meth)acrylamide, polyvinyl ester (for example, polyvinyl acetate), polyacrylonitrile, polyolefins (for example, polyethylene), polystyrene, benzoguanamine resin, formaldehyde condensation polymer, epoxy resin, polyamide, polycarbonate, phenolic resin, polyvinyl carbazole, polyvinylidene chloride, and the like.

Copolymers which combine the monomers used in the above polymers, may also be used.

In the case of the copolymers, a small amount of hydrophilic repeated units may be included. Examples of monomers which form a hydrophilic repeated unit include acrylic acid, methacrylic acid, α,β-unsaturated dicarboxylic acid, hydroxyalkyl(meth)acrylate, sulfoalkyl (meth)acrylate, styrene sulfonic acid, and the like.

Examples of the organic matting agents can be found, for example, in the U.K. Patent No. 1055713, the U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821, and 57-14835.

Also, two or more types of solid particles may be used in combination. The average particle size of the solid particles may suitably be, for example, 1 μm to 100 μm, and is more preferably 4 μm to 30 μm. The usage amount of the solid particles may suitably be 0.01 g/m² to 0.5 g/m², and is more preferably 0.02 g/m² to 0.3 g/m².

The releasing agent added to the toner image-receiving layer of the present invention may also comprise different derivatives thereof, oxides, refined products and mixtures. These may also have reactive substituents.

The melting point (° C.) of the releasing agent is preferably 70° C. to 95° C., and more preferably 75° C. to 90° C., from the viewpoints of anti-offset properties and paper transport properties.

The releasing agent is also preferably a water-dispersible releasing agent, from the viewpoint of compatibility when a water-dispersible thermoplastic resin is used as the thermoplastic resin in the toner image-receiving layer.

The content of the releasing agent in the toner image-receiving layer is preferably 0.1% by mass to 10% by mass, more preferably 0.3% by mass to 8.0% by mass, and still more preferably 0.5% by mass to 5.0% by mass.

—Colorant—

Examples of colorants include fluorescent whitening agents, white pigments, colored pigments, dyes, and the like.

The fluorescent whitening agent has absorption in the near-ultraviolet region, and is a compound which emits fluorescence at 400 nm to 500 nm. The various fluorescent whitening agent known in the art may be used without any particular limitation.

Examples of the fluorescent whitening agent include the compounds described in “The Chemistry of Synthetic Dyes” Volume V, Chapter 8 edited by K. VeenRataraman. Specific examples of the fluorescent whitening agent include stilbene compounds, coumarin compounds, biphenyl compounds, benzo-oxazoline compounds, naphthalimide compounds, pyrazoline compounds, carbostyryl compounds, and the like. Examples of these include white furfar-PSN, PHR, HCS, PCS, and B from Sumitomo Chemicals, UVITEX-OB from Ciba-Geigy, Co., Ltd., and the like.

Examples of the white pigments include the inorganic pigments described in the “fillers,” (for example, titanium oxide, calcium carbonate, and the like).

Examples of the colored pigments include various pigments and azo pigments described in JP-A No. 63-44653, (for example, azo lakes such as carmine 6B and red 2B, insoluble azo compounds such as monoazo yellow, disazo yellow, pyrazolo orange, Balkan orange, and condensed azo compounds such as chromophthal yellow and chromophthal red), polycyclic pigments (for example, phthalocyanines such as copper phthalocyanine blue and copper phthalocyanine green), thioxadines such as thioxadine violet, isoindolinones such as isoindolinone yellow, surenes such as perylene, perinon, hulavanthoron and thioindigo, lake pigments (for example, malachite green, rhodamine B, rhodamine G and Victoria blue B), and inorganic pigment (for example, oxide, titanium dioxide, iron oxide red, sulfate; settling barium sulfate, carbonate; settling calcium carbonate, silicate; hydrous silicate, silicic anhydride, metal powder; alminium powder, bronze powder, zinc powder, carbon black, chrome yellow, iron blue, or the like) and the like.

These may be used either alone, or in combination of two or more. Of these, titanium oxide is particularly preferred as the pigment.

There is no particular limitation on the form of the pigment. However, hollow particles are preferred from the viewpoint that they have excellent heat conductivity (low heat conductivity) during image fixing.

The various dyes known in the art may be used as the dye.

Examples of oil-soluble dyes include anthraquinone compounds, azo compounds, and the like.

Examples of water-insoluble dyes include vat dyes such as C.I.Vat violet 1, C.I.Vat violet 2, C.I.Vat violet 9, C.I.Vat violet 13, C.I.Vat violet 21, C.I.Vat blue 1, C.I.Vat blue 3, C.I.Vat blue 4, C.I.Vat blue 6, C.I.Vat blue 14, C.I.Vat blue 20 and C.I.Vat blue 35, or the like; disperse dyes such as C.I. disperse violet 1, C.I. disperse violet 4, C.I. disperse violet 10, C.I. disperse blue 3, C.I. disperse blue 7, C.I. disperse blue 58, or the like; and oil-soluble dyes such as C.I. solvent violet 13, C.I. solvent violet 14, C.I. solvent violet 21, C.I. solvent violet 27, C.I. solvent blue 11, C.I. solvent blue 12, C.I. solvent blue 25, C.I. solvent blue 55, or the like.

Colored couplers used in silver halide photography may also be preferably used.

A content (g/m²) of the colorant in the toner image-receiving layer (surface) is preferably 0.1 g/m² to 8 g/m², and more preferably 0.5 g/m² to 5 g/m².

If the content of colorant is less than 0.1 g/m², the light transmittance in the toner image-receiving layer becomes high. If the content of the colorant is more than 8 g/m², handling becomes more difficult, due to crack and adhesive resistance.

In the colorant, an amount of the pigment to be added is, based on the mass of the thermoplastic resin which forms the toner image-receiving layer, less than 40% by mass, more preferably less than 30% by mass, and still more preferably less than 20% by mass.

—Filler—

The filler may be an organic or inorganic filler. Reinforcers for binder resins, bulking agents and reinforcements known in the art may be used. The filler may be selected, referring into “Handbook of Rubber and Plastics Additives” (ed. Rubber Digest Co.), “Plastics Blending Agents—Basics and Applications” (New Edition) (Taisei Co.), “The Filler Handbook” (Taisei Co.), or the like.

As the filler, various inorganic fillers (or pigments) can be used. Examples of inorganic pigments include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate, mullite, and the like.

Silica and alumina are particularly preferred. These fillers may be used either alone or in combination of two or more. It is preferred that the filler has a small particle diameter. If the particle diameter is large, the surface of the toner image-receiving layer tends to become rough.

Examples of the silica include spherical silica and amorphous silica. The silica may be synthesized by the dry method, wet method or aerogel method. The surface of the hydrophobic silica particles may also be treated by trimethylsilyl groups or silicone. Colloidal silica is preferred. The average particle diameter of the silica is preferably 200 nm to 5000 nm.

The silica is preferably porous. The average particle diameter of the porous silica is preferably 4 nm to 120 nm, and more preferably 4 nm to 90 nm. The average pore volume per mass of porous silica is preferably 0.5 ml/g to 3 ml/g, for example.

The alumina includes anhydrous alumina and hydrated alumina. Examples of crystallized anhydrous aluminas which may be used, are α, β, γ, δ, ξ, η, θ, κ, ρ, or χ. Hydrated alumina is preferred to anhydrous alumina. The hydrated alumina may be a monohydrate or trihydrate. Monohydrates include pseudo-boehmite, boehmite and diaspore. Trihydrates include gibbsite and bayerite. The average particle diameter of alumina is preferably 4 nm to 300 nm, and more preferably 4 nm to 200 nm. Porous alumina is preferred. The average pore size of porous alumina is preferably 50 nm to 500 nm. The average pore volume per mass of porous alumina is around 0.3 ml/g to 3 ml/g.

The alumina hydrate can be synthesized by the sol-gel method, in which ammonia is added to an aluminum salt solution to precipitate alumina, or by hydrolysis of an alkali aluminate. Anhydrous alumina can be obtained by dehydrating alumina hydrate by the action of heat.

It is preferred that the filler of 5 parts by mass to 2000 parts by mass is added, relative to the dry mass of the binder in the toner image-receiving layer where the filler is to be added.

—Crosslinking Agent—

A crosslinking agent can be added in order to adjust the storage stability or thermoplastic properties of the toner image-receiving layer. Examples of the crosslinking agent include compounds containing two or more reactive groups in the molecule, such as an epoxy group, an isocyanate group, an aldehyde group, an active halogen group, an active methylene group, an acetylene group and other reactive groups known in the art.

The crosslinking agent may also be a compound having two or more groups capable of forming bonds such as hydrogen bonds, ionic bonds, stereochemical bonds, or the like.

The crosslinking agent may be a compound known in the art such as a coupling agent for resin, curing agent, polymerizing agent, polymerization promoter, coagulant, film-forming agent, film-forming assistant, or the like. Examples of the coupling agents include chlorosilanes, vinylsilanes, epoxysilanes, aminosilanes, alkoxyaluminum chelates, titanate coupling agents, and the like. The examples further include other agents known in the art such as those mentioned in Handbook of Rubber and Plastics Additives (ed. Rubber Digest Co.).

—Charge Control Agent—

It is preferred that the toner image-receiving layer contains a charge control agent to adjust toner transfer and adhesion, and to prevent charge adhesion. The charge control agent may be any charge control agent known in the art. Examples of the charge control agent include surfactants such as a cationic surfactant, an anionic surfactant, an amphoteric surfactant, a nonionic surfactant, or the like; polymer electrolytes, electroconducting metal oxides, and the like. When the toner has a negative charge, it is preferred that the charge control agent blended with the toner image-receiving layer is, for example, cationic or nonionic.

Specific examples include cationic charge inhibitors such as quaternary ammonium salts, polyamine derivatives, cation-modified polymethylmethacrylate, cation-modified polystyrene, or the like; anionic charge inhibitors such as alkyl phosphates, anionic polymers, or the like; and nonionic charge inhibitors such as aliphatic ester, polyethylene oxide, or the like. The examples are not limited thereto, however.

Examples of the electroconducting metal oxides include ZnO, TiO₂, SnO₂, Al₂O₃, In₂O₃, SiO₂, MgO, BaO, MoO₃, and the like. These electroconducting metal oxides may be used alone, or may be used in the form of a complex oxide. Moreover, the metal oxide may contain other elements. For example, ZnO may contain Al, In, or the like, TiO₂ may contain Nb, Ta, or the like, and SnO₂ may contain (or, dope) Sb, Nb, halogen elements, or the like.

—Other Additives—

The materials used to obtain the toner image-receiving layer may also contain various additives to improve image stability when output, or to improve stability of the toner image-receiving layer itself. Examples of the additives used for these purposes include antioxidants, age resistors, degradation inhibitors, anti-ozone degradation inhibitors, ultraviolet ray absorbers, metal complexes, light stabilizers, preservatives, fungicide, and the like.

Examples of the antioxidants include chroman compounds, coumarane compounds, phenol compounds (for example, hindered phenols), hydroquinone derivatives, hindered amine derivatives, spiroindan compounds, and the like. The antioxidants can be found, for example, in JP-A No. 61-159644.

Examples of the age resistors can be found in “Handbook of Rubber and Plastics Additives,” Second Edition (1993, Rubber Digest Co.), pp. 76-121.

Examples of the ultraviolet ray absorbers include benzotriazo compounds (described in the U.S. Pat. No. 3,533,794), 4-thiazolidone compounds (described in the U.S. Pat. No. 3,352,681), benzophenone compounds (described in JP-A No. 46-2784), ultraviolet ray absorbing polymers (described in JP-A No. 62-260152).

Examples of the metal complexes can be found in the U.S. Pat. Nos. 4,241,155, 4,245,018, 4,254,195, and JP-A Nos. 61-88256, 62-174741, 63-199248, 01-75568, 01-74272.

The ultraviolet ray absorbers and the light stabilizers can be found in Handbook of Rubber and Plastics Additives, Second Edition (1993, Rubber Digest Co.), pp. 122-137 may also be used.

Additives for photography known in the art may also be added to the material used to obtain the toner image-receiving layer as described above. Examples of the photographic additives can be found in the Journal of Research Disclosure (hereinafter referred to as RD) No. 17643 (December 1978), No. 18716 (November 1979) and No. 307105 (November 1989). The relevant sections are shown.

| Type of additive | RD17643 | RD18716 | RD307105 |
|---|---|---|---|
| 1. Whitener | p24 | p648, right-hand | p868 |
| | | column | |
| 2. Stabilizer | pp.24-25 | p649, right-hand | pp.868-870 |
| | | column | |
| 3. Light absorbers | pp.25-26 | p649, right-hand | p873 |
| (ultraviolet ray | | column | |
| absorbers) | | | |
| 4. Pigment image | p25 | p650, right-hand | p872 |
| stabilizers | | column | |
| 5. Film-hardening agents | p26 | p651, left-hand | pp.874-875 |
| | | column | |
| 6. Binders | p26 | p651, left-hand | pp.873-874 |
| | | column | |
| 7. Plasticizers, lubricants | p27 | p650, right-hand | p876 |
| | | column | |
| 8. Coating assistants | pp.26-27 | p650, right-hand | pp.875-876 |
| (surfactants) | | column | |
| 9. Antistatic agents | p27 | p650, right-hand | pp.867-877 |
| | | column | |
| 10. Matting agents | | | pp.878-879 |

The toner image-receiving layer is formed by applying a coating solution which contains the polymer used for the toner image-receiving layer with a wire coater or the like onto the support, and drying the coating solution. The coating solution is prepared by dissolving or uniformly dispersing an additive such as a thermoplastic polymer, a plasticizer, or the like, into an organic solvent such as alcohol, ketone, or the like. The organic solvent used here may for example be methanol, isopropyl alcohol, methyl ethyl ketone, or the like. If the polymer used for the toner image-receiving layer is water-soluble, the toner image-receiving layer can be prepared by applying an aqueous solution of the polymer onto the support. Polymers which are not water-soluble may be applied onto the support in an aqueous dispersion.

The film-forming temperature of the polymer is preferably room temperature or higher, from the viewpoint of pre-print storage, and preferably 100° C. or lower, from the viewpoint of fixing toner particles.

The toner image-receiving layer is coated so that the amount of coating in mass after drying is preferably 1 g/m² to 20 g/m², and more preferably 4 g/m² to 15 g/m².

There is no particular limitation on the thickness of the toner image-receiving layer. However, it is preferably 1 μm to 30 μm, and more preferably 2 μm to 20 μm.

—Physical Properties of Toner Image-Receiving Layer—

The 180° separation strength of the toner image-receiving layer at the fixing temperature by the fixing member is preferably 0.1N/25 mm or less, and more preferably 0.041 N/25 mm or less. The 180° separation strength can be measured based on the method described in JIS K6887 using the surface material of the fixing member.

It is preferred that the toner image-receiving layer has a high degree of whiteness. This whiteness is measured by the method specified in JIS P 8123, and is preferably 85% or more. It is preferred that the spectral reflectance is 85% or more in the wavelength of 440 nm to 640 nm, and that the difference between the maximum spectral reflectance and minimum spectral reflectance in this wavelength is within 5%. Further, it is preferred that the spectral reflectance is 85% or more in the wavelength of 400 nm to 700 nm, and that the difference between the maximum spectral reflectance and the minimum spectral reflectance in the wavelength is within 5%.

Specifically, for the whiteness, the value of L* is preferably 80 or higher, more preferably 85 or higher, and still more preferably 90 or higher in a CIE 1976 (L*a*b*) color space. The color tint of the white color is preferably as neutral as possible. Regarding the color tint of the whiteness, the value of (a*)²+(b*)² is preferably 50 or less, more preferably 18 or less and still more preferably 5 or less in a (L*a*b*) space.

It is preferred that the toner image-receiving layer has a high surface gloss. The 45° gloss luster is preferably 60 or higher, more preferably 75 or higher, and still more preferably 90 or higher, over the whole range from white where there is no toner, to black where toner is densed at maximum.

However, the gloss luster is preferably 110 or less. If it is more than 110, the image has a metallic appearance which is undesirable.

Gloss luster may be measured by JIS Z 8741.

It is preferred that the toner image-receiving layer has a high smoothness. The arithmetic average roughness (Ra) is preferably 3 μm or less, more preferably 1 μm or less, and still more preferably 0.5 μm or less, over the whole range from white where there is no toner, to black where toner is densed at maximum.

Arithmetic average roughness may be measured by JIS B 0601, B 0651, and B 0652.

It is preferred that the toner image-receiving layer has one of the following physical properties, more preferred that it has several of the following physical properties, and most preferred that it has all of the following physical properties.

(1) Tg (glass transition temperature) of the toner image-receiving layer is 40° C. or higher.

(2) T1/2 (a softening point measured by ½ method) of the toner image-receiving layer is 60° C. to 200° C., and preferably 80° C. to 170° C. Herein, the softening point measured by the ½ method is measured using a specific apparatus. The softening point is taken to be the temperature which is ½ of the difference in piston strokes when flow starts and flow ends at various temperatures, when the temperature is increased at a predetermined uniform rate after a residual heat time of, for example, 300 seconds, at the initial set temperature (for example, 50° C.), while applying a predetermined extrusion load under specific conditions.

(3) Tfb (flow beginning temperature) of the toner image-receiving layer is 40° C. to 200° C., and Tfb of the toner image-receiving layer is preferably Tfb of the toner plus 50° C., or less.

(4) The temperature at which the viscosity of the toner image-receiving layer is 1×10⁵ cp is 40° C. or higher, lower than the corresponding temperature for the toner.

(5) At a fixing temperature of the toner image-receiving layer, the storage elasticity modulus (G′) is 1×10² Pa to 1×10⁵ Pa, and the loss elasticity modulus (G″) is 1×10² Pa to 1×10⁵ Pa.

(6) The loss tangent (G″/G′), which is the ratio of the loss elasticity modulus (G″) and the storage elasticity modulus (G′) at a fixing temperature of the toner image-receiving layer, is 0.01 to 10.

(7) The storage modulus (G′) at a fixing temperature of the toner image-receiving layer is minus 50 to plus 2500, relative to the storage elasticity modulus (G″) at a fixing temperature of the toner.

(8) The inclination angle on the toner image-receiving layer of the molten toner is 50° or less, and particularly preferably 40° or less. The toner image-receiving layer preferably satisfies the physical properties described in Japanese Patent No. 2788358, and JP-A Nos. 07-248637, 08-305067 and 10-239889.

Physical property (1) may be measured by a differential scanning calorimeter (DSC). Physical properties (2) and (3) may be measured, for example, by Flow Tester CFT-500 or 500D produced by Shimadzu Corporation. Physical properties (5) to (7) may be measured using a rotating rheometer (for example, Dynamic Analyzer RADII produced by Rheometric Scientific F. E. Ltd.). Physical property (8) may be measured by the process disclosed in JP-A No. 08-334916 using a Contact Angle Measurement Apparatus, Kyowa Interface Science Co., LTD.

It is preferred that the surface electrical resistance of the toner image-receiving layer is 1×10⁶ Ω/cm² to 1×10¹⁵ Ω/cm² (under conditions of 25° C., 65% RH).

If the surface electrical resistance is less than 1×10⁶ Ω/cm², the toner amount transferred to the toner image-receiving layer is insufficient, and the density of the toner image obtained may be too low. On the other hand, if the surface electrical resistance is more than 1×10¹⁵ Ω/cm², more charge than necessary is produced during transfer. Therefore, toner is transferred insufficiently, image density is low and static electricity develops causing dust to adhere during handling of the electrophotographic image-receiving sheet, or misfeed, overfeed, discharge marks or toner transfer dropout may occur.

The surface electrical resistance of the surface on the opposite surface of the support to the toner image-receiving layer is preferably 5×10⁸ Ω/cm² to 3.2×10¹⁰ Ω/cm², and more preferably 1×10⁹ Ω/cm² to 1×10¹⁰ Ω/cm².

The surface electrical resistances are measured based on JIS K 6911. The sample is left with air-conditioning for 8 hours or more at a temperature of 20° C. and the humidity of 65%. Measurements are made using an R8340 produced by Advantest Ltd., under the same environmental conditions after giving an electric current for 1 minute at an applied voltage of 100V.

[Other Layers]

Other layers may include, for example, a surface protective layer, backing layer, contact improving layer, intermediate layer, undercoat, cushion layer, charge control (inhibiting) layer, reflecting layer, tint adjusting layer, storage ability improving layer, anti-adhering layer, anti-curl layer, smoothing layer, and the like. These layers may have a single-layer structure or may be formed of two or more layers.

—Surface Protective Layer—

A surface protective layer may be disposed on the surface of the toner image-receiving layer to protect the surface of the electrophotographic image-receiving sheet, to improve storage properties, to improve ease of handling, to facilitate writing, to improve paper transporting properties within an equipment, to confer anti-offset properties, or the like. The surface protective layer may comprise one layer, or two or more layers. In the surface protective layer, various thermoplastic resins or thermosetting resins may be used as binders, and are preferably the same types of resins as those of the toner image-receiving layer. However, the thermodynamic properties and electrostatic properties are not necessarily identical to those of the toner image-receiving layer, and may be individually optimized.

The surface protective layer may comprise the various additives described above which can be used for the toner image-receiving layer. In particular, in addition to the releasing agents, the surface protective layer may include other additives, for example matting agents or the like. The matting agents may be any of these used in the related art.

From the viewpoint of fixing properties, it is preferred that the outermost surface layer of the electrophotographic image-receiving sheet (which refers to, for example, the surface protective layer, if disposed) has good compatibility with the toner. Specifically, it is preferred that the contact angle with molten toner is for 0° to 40°.

—Backing Layer—

It is preferred that, in the electrophotographic image-receiving sheet, a backing layer is disposed on the opposite surface to the surface on which the support is disposed, in order to confer back surface output compatibility, and to improve back surface output image quality, curl balance and paper transporting properties within equipment.

There is no particular limitation on the color of the backing layer. However, if the electrophotographic image-receiving sheet of the invention is a double-sided output image-receiving sheet where an image is formed also on the back surface, it is preferred that the backing layer is also white. It is preferred that the whiteness and spectral reflectance are 85% or more, for both the top surface and the back surface.

To improve double-sided output compatibility, the backing layer may have an identical structure to that of the toner image-receiving layer. The backing layer may comprise the various additives described hereintofore. Of these additives, matting agents and charge control agents are particularly suitable. The backing layer may be a single layer, or may have a laminated structure comprising two or more layers.

Further, if releasing oil is used for the fixing roller or the like, to prevent offset during fixing, the backing layer may have oil absorbing properties.

—Intermediate Layer—

An intermediate layer may for example be disposed between the support and a contact improvement layer, between a contact improvement layer and a cushion layer, between a cushion layer and a toner image-receiving layer, or between a toner image-receiving layer and a storage property improvement layer. In the case of an electrophotographic image-receiving sheet comprising a support, a toner image-receiving layer and an intermediate layer, the intermediate layer may of course be disposed for example between the support and the toner image-receiving layer.

—Contact Improving Layer—

In the electrostatic image-receiving sheet, it is preferred to dispose a contact improving layer in order to improve the contact between the support and the toner image-receiving layer. The contact improving layer may contain the various additives described above. Of these, crosslinking agents are particularly preferred to be blended in the contact improving layer. Furthermore, to improve accepting properties to toner, it is preferred that the electrophotographic image-receiving sheet further comprises a cushion layer between the contact improving layer and the toner image-receiving layer.

The thickness of the electrophotographic image-receiving sheet of the present invention can be suitably selected according to the purpose without particular limitation. The thickness is preferably 50 μm to 500 μm, and more preferably 100 μm to 350 μm.

<Toner>

In the electrophotographic image-receiving sheet, the toner image-receiving layer receives toners during printing or copying.

The toner contains at least a binder resin and a colorant, but may contain releasing agents and other components, if necessary.

—Binder Resin for Toner—

There is no particular limitation on the binder resin. The binder resin can be selected from those ordinarily used in the toner.

Examples of the binder resin include vinyl monopolymer of: styrenes such as styrene, parachlorostyrene, or the like; vinyl esters such as vinyl naphthalene, vinyl chloride, vinyl bromide, vinyl fluoride, vinyl acetate, vinyl propioniate, vinyl benzoate, vinyl butyrate, or the like; methylene aliphatic carboxylates such as methyl acrylate, ethyl acrylate, n-butyl acrylate, isobutyl acrylate, dodecyl acrylate, n-octyl acrylate, 2-chloroethyl acrylate, phenyl acrylate, α-methyl chloroacrylate, methyl methacrylate, ethyl methacrylate, butyl acrylate, or the like; vinyl nitriles such as acryloniotrile, methacrylonitrile, acrylamide, or the like; vinyl ethers such as vinyl methyl ether, vinyl ethyl ether, vinyl isobutyl ether, or the like; N-vinyl compounds such as N-vinyl pyrrole, N-vinylcarbazole, N-vinyl indole, N-vinyl pyrrolidone, or the like; and vinyl carboxylic acids such as methacrylic acid, acrylic acid, cinnamic acid, or the like. These vinyl monomers may be used either alone, or copolymers thereof may be used. Of these resins, it is preferable to use a resin of the same type as the resin used for the toner image-receiving layer.

—Colorants for the Toner—

The colorants generally used in the art can be used without limitation. Examples of the colorants include carbon black, chrome yellow, Hansa yellow, benzidine yellow, threne yellow, quinoline yellow, permanent orange GTR, pyrazolone orange, Balkan orange, watch young red, permanent red, brilliant carmin 3B, brilliant carmin 6B, dippon oil red, pyrazolone red, lithol red, rhodamine B lake, lake red C, rose bengal, aniline blue, ultramarine blue, chalco oil blue, methylene blue chloride, phthalocyanine blue, phthalocyanine green, malachite green oxalate, or the like. Various dyes may also be added such as acridine, xanthene, azo, benzoquinone, azine, anthraquinone, thioindigo, dioxadine, thiadine, azomethine, indigo, thioindigo, phthalocyanine, aniline black, polymethine, triphenylmethane, diphenylmethane, thiazine, thiazole, xanthene, or the like. These colorants may be used either alone, or in combination of a plurality of colorants.

It is preferred that the content of the colorant is 2% by mass to 8% by mass. If the content of colorant is 2% by mass or more, the coloration does not become weaker. If it is 8% by mass or less, transparency does not deteriorate.

—Releasing Agent for the Toner—

The releasing agent may be in principle any of the wax known in the art. Polar wax containing nitrogen such as highly crystalline polyethylene wax having relatively low molecular weight, Fischertropsch wax, amide wax, urethane wax, and the like are particularly effective. For polyethylene wax, it is particularly effective if the molecular weight is 1000 or less, and is effective more preferably if the molecular weight is 300 to 1000.

Compounds containing urethane bonds have a solid state due to the strength of the cohesive force of the polar groups even if the molecular weight is low, and as the melting point can be set high in view of the molecular weight, they are suitable. The preferred molecular weight is 300 to 1000. The initial materials may be selected from various combinations such as a diisocyane acid compound with a mono-alcohol, a monoisocyanic acid with a mono-alcohol, dialcohol with mono-isocyanic acid, tri-alcohol with a monoisocyanic acid, and a triisocyanic acid compound with mono-alcohol. To prevent the increase of molecular weight, it is preferred to use a combination of compounds with polyfunctional groups and monofunctional groups, and it is important to use equivalent amounts of functional groups.

Among the initial materials, examples of the monoisocyanic acid compounds include dodecyl isocyanate, phenyl isocyanate and derivatives thereof, naphthyl isocyanate, hexyl isocyanate, benzyl isocyanate, butyl isocyanate, allyl isocyanate, and the like.

Examples of the diisocyanic acid compounds include tolylene diisocyanate, 4,4′-diphenylmethane diisocyanate, toluene diisocyanate, 1,3-phenylene diisocyanate, hexamethylene diisocyanate, 4-methyl-m-phenylene diisocyanate, isophorone diisocyanate, and the like.

Examples of the mono-alcohol include ordinary alcohols such as methanol, ethanol, propanol, butanol, pentanol, hexanol, heptanol, and the like.

Among the initial materials, examples of the di-alcohols include numerous glycols such as ethylene glycol, diethylene glycol, triethylene glycol, trimethylene glycol, or the like; and examples of the tri-alcohols include trimethylol propane, triethylol propane, trimethanolethane, and the like. The present invention is not necessarily limited these examples, however.

These urethane compounds may be mixed with the resin or the colorant during kneading, as an ordinary releasing agent, and used also as a kneaded-crushed toner. Further, in a case of using an emulsion polymerization cohesion scarification toner, the urethane compounds may be dispersed in water together with an ionic surfactant, polymer acid or polymer electrolyte such as a polymer base, heated above the melting point, and converted to fine particles by applying an intense shear in a homogenizer or pressure discharge dispersion machine to manufacture a releasing agent particle dispersion of 1 μm or less, which can be used together with a resin particle dispersion, colorant dispersion, or the like.

—Toner, Other Components—

The toner may also contain other components such as internal additives, charge control agents, inorganic particles, or the like. Examples of the internal additives include metals such as ferrite, magnetite, reduced iron, cobalt, nickel, manganese, or the like; alloys or magnets such as compounds containing these metals.

Examples of the charge control agents include dyes such as quaternary ammonium salt, nigrosine compounds, dyes made from complexes of aluminum, iron and chromium, or triphenylmethane pigments. The charge control agent can be selected from the ordinary charge control agent. Materials which are difficult to become solved in water are preferred from the viewpoint of controlling ionic strength which affects cohesion and stability during melting, and the viewpoint of less waste water pollution.

The inorganic fine particles may be any of the external additives for toner surfaces generally used, such as silica, alumina, titania, calcium carbonate, magnesium carbonate, tricalcium phosphate, or the like. It is preferred to disperse these with an ionic surfactant, polymer acid or polymer base.

Surfactants can also be used for emulsion polymerization, seed polymerization, pigment dispersion, resin particle dispersion, releasing agent dispersion, cohesion or stabilization thereof.

Examples of the surfactants include anionic surfactants such as sulfuric acid ester salts, sulfonic acid salts, phosphoric acid esters, soaps, or the like; cationic surfactants such as amine salts, quaternary ammonium salts, or the like. It is also effective to use non-ionic surfactants such as polyethylene glycols, alkylphenol ethylene oxide adducts, polybasic alcohols, or the like. These may generally be dispersed by a rotary shear homogenizer or a ball mill, sand mill, dyno mill, or the like, all of which contain the media.

The toner may also contain an external additive, if necessary.

Examples of the external additive include inorganic powder, organic particles, and the like.

Examples of the inorganic particles include SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, MgSO₄, and the like.

Examples of the organic particles include aliphatic acids, derivatives thereof, and the like, powdered metal salts thereof, and resin powders such as fluorine resin, polyethylene resin, acrylic resin, or the like.

The average particle diameter of the powder may be, for example, 0.01 μm to 5 μm, and is more preferably 0.1 μm to 2 μm.

There is no particular limitation on the process of manufacturing the toner, but it is preferably manufactured by a process comprising the steps of (i) forming cohesive particles in a dispersion of resin particles to manufacture a cohesive particle dispersion, (ii) adding a fine particle dispersion to the cohesive particle dispersion so that the fine particles adhere to the cohesive particles, thus forming adhesion particles, and (iii) heating the adhesion particles which melt to form toner particles.

—Physical Properties for Toner—

It is preferred that the volume average particle diameter of the toner is from 0.5 μm to 10 μm.

If the volume average particle diameter of the toner is too small, it may have an adverse effect on handling of the toner (supplementation, cleaning properties, fluidability, or the like), and productivity of the particles may deteriorate. On the other hand, if the volume average particle diameter is too large, it may have an adverse effect on image quality and resolution, both of which lead to granulariness and transferring properties.

It is preferred that the toner satisfies the above volume average particle diameter range, and that the volume average particle distribution index (GSDv) is 1.3 or less.

It is preferred that the ratio (GSDv/GSDn) of the volume average polymer distribution index (GSDv) and the number average particle distribution index (GSDn) is 0.95 or more.

It is preferred that the toner satisfies the volume average particle diameter range, and that the average value of the formation coefficient expressed by the following equation is 1.00 to 1.50;
Formation coefficient=(π×L²)/(4×S)
(where, “L” is the maximum length of the toner particles, and “S” is the projection surface area of a toner particle).

If the toner satisfies the above conditions, it has a desirable effect on image quality, and in particular, on granulariness and resolution. Also, there is less risk of dropout and blur accompanying with toner transferring, and less risk of adverse effect on handling properties, even if the average particle diameter is not small.

The storage elasticity modulus G′ (measured at an angular frequency of 10 rad/sec) of the toner itself at 150° C. is 10 Pa to 200 Pa, which is suitable for improving image quality and preventing offset at a fixing step.

(Process for Image Formation)

In an aspect of the process for image formation of the present invention, a toner image is formed on a surface of the electrophotographic image-receiving sheet, the toner image on the electrophotographic image-receiving sheet is heated and pressurized by a fixing belt and fixing roller, and then cooled so as to separate the surface of the electrophotographic image-receiving sheet from the fixing belt.

In another aspect of the process for image formation of the present invention, a toner image is formed on a surface of the electrophotographic image-receiving sheet and fixed by a heating roller. Thereafter, the surface of the electrophotographic image-receiving sheet is heated and pressurized by a fixing belt and fixing roller, cooled, and separated from the fixing belt.

The process for transferring of the present invention utilizes ordinary processes employed in a process for electrophotography. Specifically, one of the ordinary processes may be directly transferring a toner image formed on a development roller onto an electrophotographic image-receiving sheet. The process may be the intermediate transfer belt process, where a toner image is primarily transferred onto an intermediate transfer belt, and is then transferred onto an electrophotographic image-receiving sheet. From the viewpoints of surrounding stability and higher quality image, the intermediate transfer belt process is more preferable.

Regarding the electrophotographic image-receiving sheet of the present invention, the toner transferred to the electrophotogrpahic image-receiving sheet is fixed on the electrophotographic image-receiving sheet using an apparatus for electrophotography having a fixing belt. The belt fixing method may for example be the oilless apparatus for electrophotography as described in JP-A No. 11-352819, or the method where a secondary transfer and fixing are realized simultaneously as described in JP-A Nos. 11-231671 and 05-341666.

An apparatus for electrophotography having a fixing belt according to the present invention may be an apparatus for electrophotography including for example at least a heating and pressurizing part which can melt and pressurize the toner, a fixing belt which can transport the electrophotographic image-receiving sheet with adhering toner while in contact with the toner image-receiving layer, and a cooling part which can cool the heated image-receiving sheet while it is still adhering to the fixing belt.

By using the electrophotographic image-receiving sheet having the toner image-receiving layer in the apparatus for electrophotography which includes the fixing belt, toner adhering to the toner image-receiving layer is fixed in fine detail without spreading onto the electrophotographic image-receiving sheet, and the molten toner is cooled and solidified, while adhering closely to the fixing belt. In this way, the toner is received onto the electrophotogrpahic image-receiving sheet with completely embedded in the toner image-receiving layer. Therefore, there are no image discrepancies, and a glossy and smooth toner image is obtained.

The electrophotographic image-receiving sheet is particularly suitable for forming an image by the oilless belt fixing method, and it permits a large improvement of offset. However, other methods for forming an image may also likewise be used.

For example, by using the electrophotographic image-receiving sheet, a full-color image can easily be formed while improving image quality and preventing cracks. A full-color image can be formed using an apparatus for electrophotography capable of forming full-color images. An ordinary apparatus for electrophotography includes an image-receiving paper transporting part, latent image-forming part, and developing part disposed in the vicinity of the latent image-forming part.

To improve image quality, adhesive transfer or heat assistance transfer may be used instead of the electrostatic transfer or bias roller transfer, or in combination therewith. Specific details of these methods are given for example in JP-A Nos. 63-113576 and 05-341666. It is particularly preferred to use an intermediate transfer belt in the heat assistance transfer method. Also, it is preferred to provide a cooling device for the intermediate belt after toner transfer or in the latter half of the toner transfer to the electrophotographic image-receiving sheet. Due to this cooling device, the toner (toner image) is cooled to the softening point of the binder resin or lower, or the glass transition temperature of the toner plus 10° C. or less, hence the image is transferred to the electrophotographic image-receiving sheet efficiently and can be separated away from the intermediate transfer belt.

The fixing is an important step that influences the glossiness and the smoothness of the toner image in a final state. The fixing method may be carried out by a heating and pressurizing roller, or belt fixing using a belt, but from the viewpoint of image quality such as gloss and smoothness, belt fixing is preferred. Belt fixing methods known in the art include for example an oil-less belt fixing described in JP-A No. 11-352819, and the method where secondary transfer and fixing are realized simultaneously as described in JP-A Nos. 11-231671 and 05-341666. Further, a primary fixing may also be performed by a heat roller before the heating and pressurizing by the fixing belt and fixing roller.

The surface of the fixing belt may receive a surface treatment of a silicone compound, fluorine compound or a combination thereof to prevent peeling of the toner and prevent offset of the toners. Also, it is preferred to provide a belt cooling device in the latter half of fixing, which improves the separation of the electrophotographic image-receiving sheet. The cooling temperature is preferably the softening point or lower, or the glass transition temperature plus 10° C. or lower, of a binder resin used for the toner and/or the polymer in the toner image-receiving layer of the electrophotographic image-receiving sheet. On the other hand, in the initial stage of fixing, the temperature of the toner image-receiving layer or toner on the electrophotographic image-receiving sheet must be raised to the temperature at which the toner or the toner image-receiving layer becomes sufficiently softened. Specifically, it is preferred in practice that the cooling temperature is 30° C. to 70° C., and that it is 100° C. to 180° C. at the initial stage of fixing.

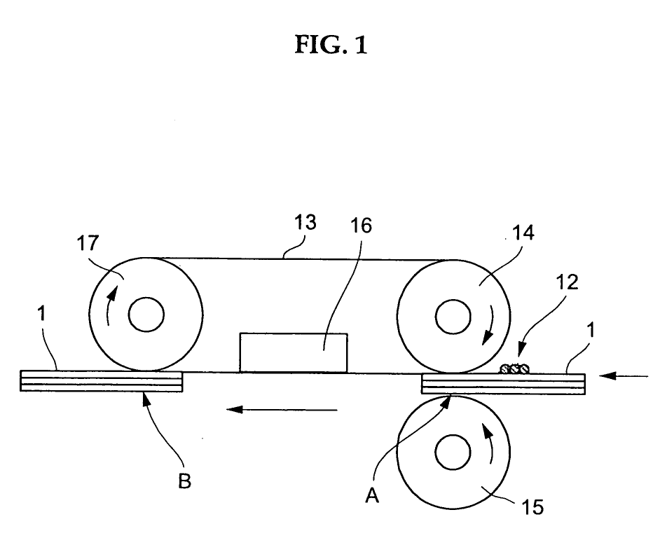

Hereinafter, an example of the apparatus for image formation having a typical fixing belt will be described referring into FIG. 1. It should however be understood that the present invention is not limited to the aspect shown in FIG. 1.

First, toners (12) are transferred onto an electrophotographic image-receiving sheet (1) by an apparatus for image formation, (which is not shown in FIG. 1). The electrophotographic image-receiving sheet (1) to which the toners (12) adhere is transported to a point A by a transporting equipment (which is not shown in FIG. 1), and is transported between a heat roller (14) and pressurizing roller (15), and is thereby heated and pressurized to temperature (fixing temperature) and to pressure at which a toner image-receiving layer of the electrophotographic image-receiving sheet (1), or the toner (12), are sufficiently softened.

Herein, the fixing temperature means the temperature of the toner image-receiving layer surface measured at the position between the heat roller (14) and the pressurizing roller (15), which is nip part at the point A, and is for example 80° C. to 190° C., and more preferably 100° C. to 170° C. The pressure means the pressure of the toner image-receiving layer surface measured at a portion between the heat roller (14) and the pressurizing roller (15), which is the nip part, and is for example 1 kg/cm² to 10 kg/cm², and more preferably 2 kg/cm² to 7 kg/cm². While the electrophotographic image-receiving sheet (1) is thus heated and pressurized, and is transported to the cooling device (16) by a fixing belt (13), a releasing agent (not shown), which was present in a discrete state inside the toner image-receiving layer, becomes melted by sufficient heating and moves up to a surface of the toner image-receiving layer. The releasing agent that moved up to the surface of the toner image-receiving layer forms a layer (a film) of the releasing agent. Thereafter, the electrophotographic image-receiving sheet (1) is transported to the cooling device (16) with the fixing belt (13), and is cooled for example to the softening point of the binder resin or lower, or the glass transition temperature plus 10° C. or lower of the binder resin used in the polymer and/or toner on the toner image-receiving layer, which is preferably 20° C. to 80° C., and more preferably room temperature (25° C.). In this way, the layer (film) of releasing agent disposed on the surface of the toner image-receiving layer is cooled and solidified, and the layer of the releasing agent is disposed due to change in the releasing agent in the toner image-receiving layer.

The cooled electrophotographic image-receiving sheet (1) is then transported to the point B by the fixing belt (13), and the fixing belt (13) is rotated by a tension roller (17). Therefore, at the point B, the electrophotographic image-receiving sheet (1) and fixing belt (13) become separated. It is preferred to have a smaller diameter of the tension roller, so that the electrophotographic image-receiving sheet voluntarily separates from the belt with its own rigidity (strength).

The fixing belt is preferably an endless belt comprising polyimide, electroforming nickel and alminium as a base material.

A thin layer formed of at least one selected from silicone rubber, fluorine rubber, a silicone resin, and fluorine resin. At least one selected the aforementioned is disposed on a surface of the fixing belt. Of these, it is preferred to dispose a layer of fluorocarbon siloxane rubber on the surface of the fixing belt, or to dispose a layer of silicone rubber on the surface of the fixing belt, and then to dispose a layer of fluorocarbon siloxane rubber on the surface of the layer of silicone rubber.

It is preferred that the fluorocarbon siloxane rubber has a perfluoroalkyl ether group and/or a perfluoroalkyl group in a main chain thereof.

Examples of the fluorocarbon siloxane rubber include: a cured product of fluorocarbon siloxane rubber which contains (A) a fluorocarbon polymer having a fluorocarbon siloxane expressed by the following Formula 1 as its main component, and containing aliphatic unsaturated groups, (B) an organopolysiloxane and/or fluorocarbon siloxane containing two or more ≡SiH groups in one molecule, and 1 to 4 times more the molar amount of ≡SiH groups than the amount of aliphatic unsaturated groups in the fluorocarbon siloxane rubber, (C) a filler, and (D) an effective amount of catalyst; and the like.

The fluorocarbon polymer having (A) as a component comprises a fluorocarbon siloxane containing a repeated unit expressed by the following Formula 1 as its main component, and contains aliphatic unsaturated groups.

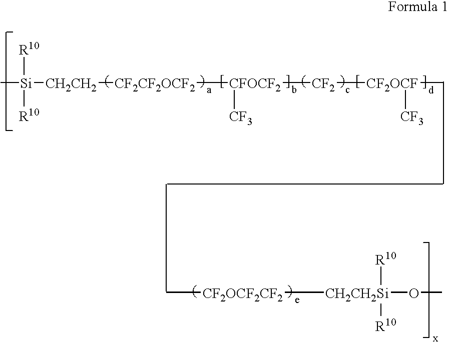

Herein, in the Formula 1, R¹⁰ is a non-substituted or substituted monofunctional hydrocarbon group preferably containing 1 to 8 carbon atoms, preferably an alkyl group containing 1 to 8 carbon atoms or an alkenyl group containing 2 to 3 carbon atoms, and particularly preferably a methyl group. “a” and “e” are respectively an integer of 0 or 1; “b” and “d” are respectively an integer of 1 to 4, and “c” is an integer of 0 to 8. “x” is an integer of 1 or more, and preferably 10 to 30.

An example of this component (A) include a substance expressed by the following Formula 2:

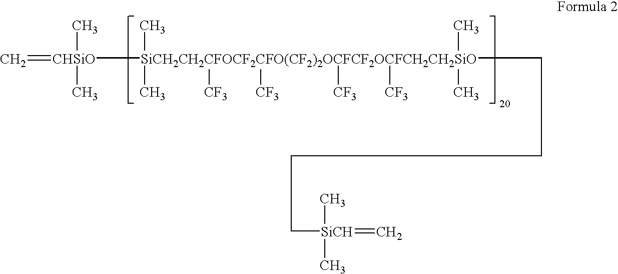

In Component (B), one example of the organopolysiloxane comprising ≡SiH groups is an organohydrogenpolysiloxane having at least two hydrogen atoms bonded to silicon atoms in the molecule.

In the fluorocarbon siloxane rubber composition, when the organocarbon polymer of Component (A) comprises an aliphatic unsaturated group, the organohydrogenpolysiloxane may be used as a curing agent. Namely, in this case, the cured product is formed by an addition reaction between aliphatic unsaturated groups in the fluorocarbon siloxane, and hydrogen atoms bonded to silicon atoms in the organohydrogenpolysiloxane.

Examples of these organohydrogenpolysiloxanes include the various organohydrogenpolysiloxanes used in an addition-curing silicone rubber composition.

It is generally preferred that the organohydrogenpolysiloxane is blended in such a proportion that the number of “≡SiH groups” therein is at least one, and particularly 1 to 5, relative to one aliphatic unsaturated hydrocarbon group in the fluorocarbon siloxane of Component (A).

It is preferred that in the fluorocarbon containing ≡SiH groups, one unit of the Formula 1 or R¹⁰ in the Formula 1 is a dialkylhydrogensiloxane group, the terminal group is a ≡SiH group such as a dialkylhydrogensiloxane group, a silyl group, or the like. An example of the fluorocarbon includes those expressed by the following Formula 3.

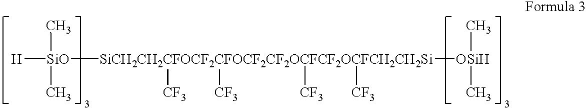

The filler, which is Component (C), may be various fillers used in ordinary silicone rubber compositions. Examples are reinforcing fillers such as mist silica, precipitated silica, carbon powder, titanium dioxide, aluminum oxide, quartz powder, talc, sericite, bentonite, or the like; fiber fillers such as asbestos, glass fiber, organic fibers or the like.

Examples of the catalyst, which is Component (D), include those any known as an addition reaction catalyst in the art. Specific examples of the catalyst include chloroplatinic acid, alcohol-modified chloroplatinic acid, complexes of chloroplatinic acid and olefins, platinum black or palladium supported on a carrier such as alumina, silica, carbon, or the like, and Group VIII elements of the Periodic Table or compounds thereof such as complexes of rhodium and olefins, chlorotris(triphenylphosphine) rhodium (an Wilkinson catalyst), rhodium (III) acetyl acetonate, or the like. It is preferred to dissolve these complexes in an alcohol solvent, an ether solvent, a hydrocarbon solvent, or the like.

Various blending agents may be added to the fluorocarbon siloxane rubber composition, to the extent that the blending agents do not interfere with the purpose of the present invention which is to improve solvent resistance. For example, dispersing agents such as diphenylsilane diol, low polymer chain end hydroxyl group-blocked dimethylpolysiloxane, hexamethyl disilazane, heat resistance improvers such as ferrous oxide, ferric oxide, cerium oxide, octyl acid iron, or the like; and colorants such as pigments or the like, may be added as a compounding agent, if necessary.

The fixing belt is obtained by coating the surface of a heat resistant resin or metal belt with the fluorocarbon siloxane rubber composition, and heat and cure it. The composition may be diluted to form a coating solution with a solvent such as m-xylene hexafluoride, benzotrifluoride, or the like. The heat curing temperature and time can be suitably selected. The heat curing temperature and time can be suitably selected within the ranges of 100° C. to 500° C. and 5 seconds to 5 hours, according to a type of the belt, a process for manufacturing the belt, or the like.

A thickness of the layer of fluorocarbon siloxane rubber is not particularly limited. The thickness is preferably 20 μm to 500 μm, and more preferably 40 μm to 200 μm, so as to obtain good fixing properties for an image, with preventing toner separation and offset of the toner at the same time.

The process for image formation to form an image on the electrophotographic image-receiving sheet is not limited to the process mentioned above, as long as it is an electrophotographic process using a fixing belt. Hence, any of the ordinary electrophotographic methods may be used.

For example, a color image may suitably be formed on the electrophotographic image-receiving sheet. A color image can be formed, using an apparatus for electrophotography which enables forming a full color image. An ordinary apparatus for electrophotography comprises an image-receiving sheet transporting part, a latent image-forming part, and a developing part disposed in the vicinity of the latent image-forming part. Depending on the type, it may also comprise, in the center of the apparatus, a toner image intermediate transfer part in the vicinity of a latent image-forming part and an image-receiving sheet transport part.

To improve image quality, adhesive transfer or heat assistance transfer methods may be used, instead of electrostatic transfer, bias roller transfer, or in combination of the heat assistance transfer methods, the electrostatic transfer, and/or the bias roller transfer. The detailed structures are described, for example, in JP-A Nos. 63-113576 and 05-341666. The intermediate transfer belt in the heat assistance transfer method is particularly preferred when toner having a small particle diameter is used.

According to the process for image formation of the present invention, separation of the electrophotographic image-receiving sheet and toner or offset of the electrophotographic image-receiving sheet and toners can be prevented, even if an oilless machine providing no fixing oil is used. A stable paper provision can be realized, and a good image with more gloss than ever, and a plenty of photographic features, can be obtained.

The present invention will now be described in further detail with reference to the following Examples and Comparative Examples. The present invention is not limited thereto, however.

In the following Examples and Comparative Examples, “%” and “part(s)” each refer to “% by mass” and “part(s) by mass.”

### EXAMPLE 1

—Preparation of Support—

A broadleaf kraft pulp (LBKP) was beaten to 300 ml (Canadian standard freeness, C.S.F.) by a disk refiner, and adjusted to a fiber length of 0.58 mm, so as to prepare pulp paper material. Various additives were added to the pulp paper material in the following proportions, based on the mass of pulp.

| Additive type | Amount (%) |
|---|---|
| Cationic starch | 1.2 |
| Alkyl ketene dimer (AKD) | 0.4 |
| Anion polyacrylamide | 0.2 |
| Epoxidized fatty acid amide (EFA) | 0.2 |
| Polyamide polyamine epichlorhydrin | 0.3 |

Notes)
AKD refers to an alkyl ketene dimer (the alkyl portion is derived from a fatty acid which is mainly composed of behenic acid), EFA refers to an epoxidized fatty acid amide (the fatty acid portion is derived from a fatty acid which is mainly composed of behenic acid).

A raw paper of weighting of 150 g/m² was manufactured from the pulp paper material obtained using a Fortlinear paper machine. In the middle of the dry zone in the Fortlinear paper machine, poly vinyl alcohol (PVA) was coated and dried so as to have weighting of 1 g/m² in solids, on the surface of the raw paper (a surface on which the toner image-receiving layer was to be disposed) by a gate roll coater.

In the final step of the paper-making process, the paper was passed through the machine so that a metal roller (surface temperature=90° C.) came in contact with the surface of the raw paper on which the toner image-receiving layer was to be disposed, and the density was adjusted to 1.01 g/cm³. In this way, a support was manufactured.

—Preparation of Toner Image-Receiving Layer Coating Solution—

(Titanium Dioxide Dispersion)

The following components were blended and dispersed using a NBK-2 available from Nippon Seiki to prepare a titanium dioxide dispersion (titanium dioxide pigment: 40% by mass).

| | |
|---|---|
| Titanium dioxide | 40.0 g |
| (TIPAQUE (registered Trademark) A-220, | |
| available from Ishihara Sangyo Kaisha, Ltd.) | |
| PVA102 | 2.0 g |
| Ion exchange water | 58.0 g |

—Toner Image-Receiving Layer Coating Solution—

The following components were mixed and stirred to prepare a toner image-receiving layer coating solution.

| | | |
|---|---|---|
| The aforementioned titanium dioxide dispersion solution | 15.5 | g |
| Carnauba wax dispersion solution | 15.0 | g |
| (Cellosol 524, available from Chukyo Yushi Co., Ltd.) | | |
| Polyester resin dispersion solution | 100.0 | g |
| (solids: 30% by mass, KZA-7049, available | | |
| from Unitika Ltd.) | | |
| Thickener | 2.0 | g |
| (Alcox E30, available from MEISEI | | |
| CHEMICAL WORKS, LTD.) | | |
| Anionic surfactants (AOT) | 0.5 | g |
| Ion exchange water | 80 | ml |

The viscosity of the toner image-receiving layer coating solution was 40 mPa·s, its surface tension was 34 mN/m, and Tg of the polyester resin was 61° C.

—Preparation of Backing Layer Coating Solution—

The following components were mixed and stirred to prepare a backing layer coating solution.

| | | |
|---|---|---|
| Acrylate resin water dispersion | 100.0 | g |
| (solids 30%, High-loss XBH-997L, available from | | |
| Seiko Chemicals) | | |
| Matting agent | 5.0 | g |
| (Techpolymer MBX-12, available from Sekisui | | |
| Chemical Industries) | | |
| Releasing agent | 10.0 | g |
| (Hydrin D337, available from Chukyo Yushi Co., Ltd.) | | |
| Thickener (CMC) | 2.0 | g |
| Anionic surfactant (AOT) | 0.5 | g |
| Ion exchange water | 80 | ml |

The viscosity of the backing layer coating solution was 35 mPa·s, and its surface tension was 33 mN/m.

<Coating a Backing Layer and a Toner Image-Receiving Layer>

The aforesaid backing layer coating solution was coated to the back surface of the support by a bar coater, and the toner image-receiving layer coating solution was coated to the upper surface of the support by a bar coater in the same way as the backing layer.

The toner image-receiving layer coating solution and backing layer coating solution were coated so that, for the backing layer, the coating amount is 9 g/m² in dry mass, and for the toner image-receiving layer, the coating amount was 12 g/m² in dry mass. The content of the thermoplastic resin in the toner image-receiving layer was 64% by mass, relative to the total mass of the toner image-receiving layer.

After the backing layer coating solution and the toner image-receiving layer coating solution were coated, they were dried by hot air, online. The air and temperature for drying were adjusted, so that drying took place within 2 minutes after coating both the back surface and a toner image-receiving surface (top surface). The drying temperature was set so that surfaces of the toner image-receiving layer and the backing layer, each of which was disposed by coating solutions, was identical to the wet-bulb temperature of the air for drying.

After drying, soft calendar treatment was carried out to a surface of the toner image-receiving layer. In the soft calender treatment, the paper was passed through using a soft calender, so that a metal roller with a surface temperature of 55° C. came in contact with the surface of the toner image-receiving layer, at the nip pressure of 235 kN/m.

<Evaluation>

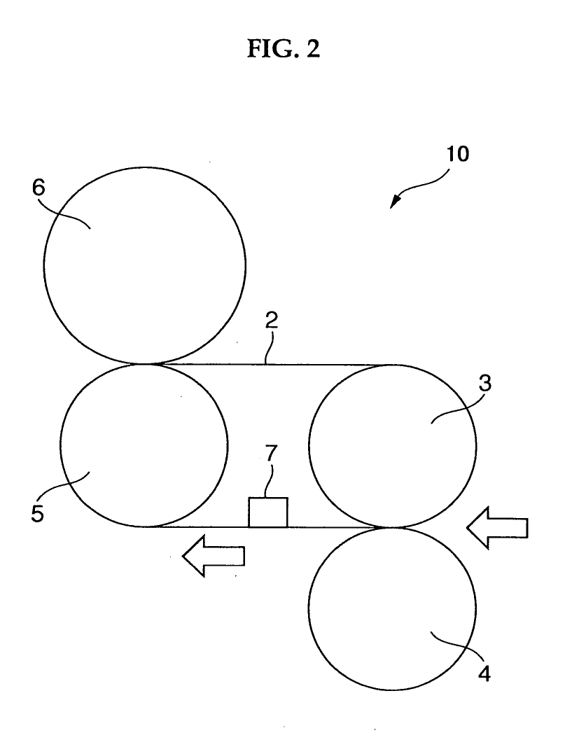

The obtained electrophotographic image-receiving sheet was cut to A4 size, and used for printing. The printer used here was a color laser printer (DocuColor 1250-PF) produced by Fuji Xerox Co., Ltd., except that an apparatus having the fixing belt shown in FIG. 2 was installed. Specifically, in the apparatus having a fixing belt 10, a fixing belt 2 is suspended around a heating roller 3 and a tension roller 5 as shown in FIG. 2. A cleaning roller 6 is provided via the fixing belt 2 above the tension roller 5, and a pressurizing roller 4 is further provided via the fixing belt 2 below the heating roller 3. In FIG. 2, starting from the right-hand side, the electrophotographic image-receiving sheet carrying a toner latent image was introduced between the heating roller 3 and the pressurizing roller 4, was fixed and transported on the fixing belt 2. Thereafter, in this process, the toner latent image was cooled by a cooling device 7, and the fixing belt 2 was finally cleaned by a cleaning roller 6.

In the apparatus having a fixing belt, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was 120° C.

<Image Quality>

The electrophotographic image-receiving sheet was cut to A4 size, a woman's portrait was printed out thereon, and evaluated in accordance with the following criteria.

[Evaluation Criteria]

A: Best

B: Good, can be used (within tolerance).

C: Poor, cannot be used (cannot be used in practice).

D: Very poor, cannot be used.

<Glossiness>

The glossiness of the electrophotographic image-receiving sheet after printing was visually observed, and the electrophotographic image-receiving sheet with the best glossiness was assigned A, followed by B, C and D on the following criteria.

[Evaluation Criteria]

A: Best

B: Good, can be used (within tolerance).

C: Poor, cannot be used (cannot be used in practice).

D: Very poor, cannot be used.

### EXAMPLES 2-6 AND COMPARATIVE EXAMPLES 1-3

The electrophotographic image-receiving sheets of Examples 2-6 and Comparative Examples 1-3 were obtained in the same way as in Example 1, except that the treatment conditions of the calendering device used for preparing the toner image-receiving layer were changed to those shown in the following Table 1.

The electrophotographic image-receiving sheets of Examples 2-6 and Comparative Examples 1-3 were evaluated for image quality and glossiness after printing, as in Example 1. The results are shown in Table 1.

### EXAMPLES 7-12

The electrophotographic image-receiving sheets of Examples 7-12 were obtained as in Examples 1-6, except that in Examples 1-6, the following double-sided polyethylene laminated paper was used instead of the raw paper.

[Double-Sided Polyethylene Laminated Paper]

A back surface PE layer having a thickness of 30 μm was disposed using an identical raw paper to that of Example 1, by extrusion coating (310° C.) of a blended product of high density polyethylene (HDPE) and low density polyethylene (LDPE) in a mass ratio (HDPE/LDPE) of 50/50 on the back surface of the raw paper. Next, a top surface PE layer was similarly disposed so that the LDPE uniformly containing 10% by mass of anatase titanium oxide on the upper surface of the raw paper had a thickness of 30 μm. A double-sided polyethylene laminated paper was thus manufactured and was taken as the support. Regarding the surface roughness of the polyolefin resin layer on the back surface (the surface on which the toner image-receiving layer was not disposed) of this support, the ten point average roughness (Rz) was 7.5 μm and the centerline average roughness (Ra) was 1.2 μm according to JIS B0601.

The electrophotographic image-receiving sheets of Examples 7-12 were respectively treated under identical calendaring apparatus treatment conditions as those of Examples 1-6 shown in Table 1, and the image quality and glossiness were evaluated as in Example 1. The results are shown in Table 1.

TABLE 1

| | Calender treatment | | Properties after printing | | |
|---|---|---|---|---|---|
| | Types of | Temperature | Nip | | |
| | Calendering | of Metal | pressure | | Image |
| | device | roller (° C.) | (kN/m) | Glossiness | quality |
| Example 1 | Soft | 55 | 235 | A | A |
| Example 2 | Soft | 60 | 196 | A | A |
| Example 3 | Soft | 35 | 235 | B | B |
| Example 4 | Soft | 53 | 210 | A | A |
| Example 5 | Long nip | 50 | 196 | A | A |
| Example 6 | Soft | 40 | 196 | B | B |
| Example 7 | Soft | 55 | 235 | A | A |
| Example 8 | Soft | 60 | 196 | A | A |
| Example 9 | Soft | 35 | 235 | A | B |
| Example 10 | Soft | 53 | 210 | A | A |
| Example 11 | Long nip | 50 | 196 | A | A |
| Example 12 | Soft | 40 | 196 | A | A |
| Comp. Ex. 1 | Soft | 28 | 196 | C | C |
| Comp. Ex. 2 | Machine | 28 | 196 | D | D |
| Comp. Ex. 3 | Machine | 20 | 196 | D | D |

From the results of Table 1, it was found out that, by subjecting the toner image-receiving layer to low temperature soft calender treatment, and additionally by use of the support having a polyethylene resin on both of the surfaces, an electrophotographic image-receiving sheet having excellent image quality and glossiness can be obtained.

### EXAMPLE 13

—Manufacturing Raw Paper—

A broadleaf kraft pulp (LBKP) was beated to 300 ml (Canadian Standard Freeness, C.S.F.) by a disk refiner, and adjusted to 0.58 mm of fiber length, so as to manufacture pulp paper material. Additives were added in the following proportions to the pulp paper material, based on the mass of pulp paper material.

| Type of additive | Amount (%) |
|---|---|
| Cationic starch | 1.2 |
| Alkyl ketene dimer (AKD) | 0.5 |
| Anionic polyacrylamide | 0.2 |
| Epoxidized fatty acid amide (EFA) | 0.3 |
| Polyamide polyamine epichlorohydrine | 0.3 |

Notes)
AKD is an alkyl ketene dimer (the alkyl portion derived from a fatty acid mainly composed of behenic acid), and EFA is an epoxidized fatty acid amide (the fatty acid portion derived from a fatty acid mainly composed of behenic acid).

A raw paper of weighting of 150 g/m² was manufactured from the pulp paper material obtained using a Fortlinear paper machine. In the middle of the dry zone in the Fortlinear paper machine, poly vinyl alcohol (PVA) was coated and dried so as to have weighting of 1 g/m² in solids, on the surface of the raw paper (a surface on which the toner image-receiving layer was to be disposed) by a gate roll coater.

In the final step of the papermaking process, the following two calendars were disposed in series and calender treatment was performed.

<Calendaring Apparatus>

(1) Soft Calendering Device (First Stage Calendar Apparatus)

The soft calendering device was disposed so that the raw paper upper surface (on which the toner image-receiving layer was to be disposed) came in contact with a metal roller (surface temperature 250° C.), and the back surface of the raw paper came in contact with a urethane resin roller (surface temperature 40° C.).

The nip pressure was 235 kN/m (240 kgf/cm).

(2) Machine Calendering Device (Second Stage Calendering Device)

The machine calendering device was disposed so that the raw paper top surface (on which the toner-image-receiving layer was to be disposed) came in contact with a metal roller (surface temperature: 190° C.), and the back surface of the raw paper came in contact with a metal roller (surface temperature: 50° C.).

The nip pressure was 147 kN/m (150 kgf/cm).

The glossiness specified by JIS P8142 on the surface of the obtained raw paper was 38%. The Beck's smoothness of the obtained raw paper was 207 seconds, and the Cobb size (30 seconds) was 4.1 g/m².

—Preparation of Toner Image-Receiving Layer Coating Solution—

(Titanium Dioxide Dispersion Solution)

The following components were mixed and dispersed using a NBK-2 available from NIPPON SEIKI to prepare a titanium dioxide dispersion solution (titanium dioxide pigment: 40% by mass).

| | |
|---|---|
| Titanium dioxide | 40.0 g |
| (TIPAQUE (registered Trademark) A-220, available | |
| from Ishihara Sangyo Kaisha, Ltd.) | |
| PVA102 | 2.0 g |
| Ion exchange water | 58.0 g |

(Toner Image-Receiving Layer Coating Solution)

The following components were mixed and stirred to prepare the toner image-receiving layer coating solution.

| | | |
|---|---|---|
| Aforementioned titanium dioxide dispersion solution | 15.5 | g |
| Carnauba wax dispersion solution | 15.0 | g |
| (Cellosol 524, available from Chukyo Yushi Co., Ltd.) | | |
| Polyester resin water dispersion | 100.0 | g |
| (solids 30%, KZA-7049, Unitika Ltd.) | | |
| Thickener (Alcox E30, MEISEI CHEMICAL WORKS, LTD) | 2.0 | g |
| Anionic surfactant (AOT) | 0.5 | g |
| Ion exchange water | 80 | ml |

The obtained toner image-receiving layer coating solution had the viscosity of 40 mPa·s, the surface tension was 34 mN/m, and the glass transition temperature (Tg) of the polyester resin was 61° C.

—Preparation of Backing Layer Coating Solution—

The following components were mixed and stirred to prepare a backing layer coating solution.

| | | |
|---|---|---|
| Acrylate resin aqueous dispersion | 100.0 | g |
| (solids 30%, high-loss XBH-997L, available | | |
| from Seiko Chemicals) | | |
| Matting agent | 5.0 | g |
| (Techpolymer MBX-12, available from Sekisui | | |
| Plastics Co., Ltd.) | | |
| Releasing agent (Hydrin D337, Chukyo Yushi Co., Ltd.) | 10.0 | g |
| Thickener (CMC) | 2.0 | g |
| Anionic surfactant (AOT) | 0.5 | g |
| Ion exchange water | 80 | ml |

The backing layer coating solution had the viscosity of 35 mPa·s, and the surface tension of 33 mN/m.

<Coating of Backing Layer and Toner Image-Receiving Layer>

The aforesaid backing layer coating solution was applied to the back surface of the obtained raw paper by a bar coater, then the aforesaid toner image-receiving layer coating solution was applied to the top surface of the raw paper by a bar coater as in the case of the backing layer.

The toner image-receiving layer coating solution and the backing layer coating solution were each coated so that, for the backing layer, the coating amount is 9 g/m² in dry mass, and for the toner image-receiving layer, the coating amount was 12 g/m² in dry mass. The content of the thermoplastic resin in the toner image-receiving layer was 64% by mass, relative to the total mass of the toner image-receiving layer.

After the backing layer coating solution and the toner image-receiving layer coating solution were coated, they were dried by hot air, online. The air and temperature for drying were adjusted, so that drying took place within 2 minutes after coating both the back surface and a toner image-receiving surface (top surface). The drying temperature was set so that surfaces of the toner image-receiving layer and the backing layer, each of which was disposed by coating solutions, was identical to the wet-bulb temperature of the air for drying.

After drying, soft calendar treatment was carried out to a surface of the toner image-receiving layer. In the soft calender treatment, the paper (electrophotographic image-receiving sheet) was passed through using a soft calender, so that a metal roller with a surface temperature of 55° C. came in contact with the surface of the toner image-receiving layer, at the nip pressure of 210 kN/m.

<Evaluation>

The obtained electrophotographic image-receiving sheet was cut to A4 size, and used for printing. The printer used here was a color laser printer (DocuColor 1250-PF) produced by Fuji Xerox Co., Ltd., except that an apparatus having the fixing belt shown in FIG. 2 was installed. Specifically, in the apparatus having a fixing belt 10, a fixing belt 2 is suspended around a heating roller 3 and a tension roller 5 as shown in FIG. 2. A cleaning roller 6 is provided via the fixing belt 2 above the tension roller 5, and a pressurizing roller 4 is further provided via the fixing belt 2 below the heating roller 3. In FIG. 2, starting from the right-hand side, the electrophotographic image-receiving sheet carrying a toner latent image was introduced between the heating roller 3 and the pressurizing roller 4, was fixed and transported on the fixing belt 2. Thereafter, in this process, the toner latent image was cooled by a cooling device 7, and the fixing belt 2 was finally cleaned by a cleaning roller 6.

In the apparatus having a fixing belt, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was 120° C.

<Image Quality>

The electrophotographic image-receiving sheet was cut to A4 size, a woman's portrait was printed out, and evaluated in accordance with the following criteria.

[Evaluation Criteria]

A: Best

B: Good, can be used (within tolerance).

C: Poor, cannot be used (cannot be used in practice).

D: Very poor, cannot be used.

<Glossiness>

The glossiness of the electrophotographic image-receiving sheet after printing was visually observed, and the paper with the best glossiness was assigned A, followed by B, C and D on the following basis.

[Evaluation Criteria]

A: Best

B: Good, can be used (within tolerance).

C: Poor, cannot be used (cannot be used in practice).

D: Very poor, cannot be used.

### EXAMPLES 14-20 AND COMPARATIVE EXAMPLES 4-8

An electrophotographic image-receiving sheet of Examples 14-20 and Comparative Examples 4-8 was manufactured in the same way as in Example 13, except that the treatment conditions of the two sets of calendar apparatus used for preparation of the raw paper were adjusted as in the following Table 2, and the treatment conditions of the calendering apparatus used for preparation of the toner image-receiving layer were as shown in the following Table 3. Image quality and glossiness were likewise evaluated. The results are shown in Tables 2 and 3.

TABLE 2

| | | | | | | | Raw |
|---|---|---|---|---|---|---|---|
| | First calender treatment | | | Second calender treatment | | | paper |
| | Type of | | Nip | Type of | Temperature | Nip | properties |
| | Calendering | Temperature of | pressure | Calendering | of Metal roller | pressure | Glossiness |
| | device | metal roller (° C.) | (kN/m) | device | (° C.) | (kN/m) | (%) |
| Example 13 | Soft | 250 | 235 | Machine | 190 | 147 | 38 |
| Example 14 | Soft | 210 | 196 | Machine | 150 | 196 | 32 |
| Example 15 | Soft | 160 | 235 | — | — | — | 26 |
| Example 16 | Machine | 150 | 196 | Soft | 210 | 196 | 30 |
| Example 17 | Machine | 210 | 216 | — | — | — | 28 |
| Example 18 | Soft | 250 | 147 | Soft | 210 | 147 | 39 |
| Example 19 | Soft | 250 | 196 | Shoe | 210 | 392 | 45 |
| Example 20 | Machine | 250 | 196 | Shoe | 210 | 392 | 43 |
| Comp. Ex. 4 | Machine | 50 | 196 | — | — | — | 7 |
| Comp. Ex. 5 | Machine | 90 | 196 | — | — | — | 9 |
| Comp. Ex. 6 | Machine | 90 | 196 | Machine | 120 | 147 | 12 |
| Comp. Ex. 7 | Machine | 120 | 196 | Machine | 120 | 147 | 19 |
| Comp. Ex. 8 | Soft | 140 | 196 | Machine | 140 | 147 | 23 |

TABLE 3

| | Calender treatment of toner | | | Properties after | |
|---|---|---|---|---|---|
| | image-receiving layer | | | printing | |
| | Types of | Metal roller | Nip | | Image |
| | Calendering | temperature | pressure | | qual- |
| | device | (° C.) | (kN/m) | Glossiness | ity |
| Example 13 | Soft | 55 | 210 | A | A |
| Example 14 | Soft | 55 | 185 | A | A |
| Example 15 | Soft | 35 | 180 | B | B |
| Example 16 | Soft | 60 | 180 | A | A |
| Example 17 | Long nip | 48 | 210 | A | A |
| Example 18 | Soft | 40 | 235 | A | A |
| Example 19 | Soft | 65 | 122 | A | A |
| Example 20 | Soft | 38 | 245 | A | A |
| Comp. Ex. 4 | Soft | 20 | 150 | C | C |
| Comp. Ex. 5 | Soft | 25 | 115 | C | C |
| Comp. Ex. 6 | Machine | 25 | 110 | D | D |
| Comp. Ex. 7 | Machine | 28 | 148 | C | C |
| Comp. Ex. 8 | Machine | 25 | 110 | D | D |

From the results of Table 2 and Table 3, it was found out that, by subjecting the raw paper to high temperature soft calender treatment, and additionally by subjecting the toner image-receiving layer to low temperature soft calender treatment, an electrophotographic image-receiving sheet having excellent image quality and glossiness can be obtained.

### EXAMPLE 21

—Preparation of Raw Paper—

A broadleaf kraft pulp (LBKP) was beaten to 300 ml (Canadian standard freeness, C.S.F.) by a disk refiner, and adjusted to a fiber length of 0.58 mm, so as to prepare pulp paper material. Various additives were added to the pulp paper material in the following proportions, based on the mass of pulp.

| Additive type | Amount (%) |
|---|---|
| Cationic starch | 1.2 |
| Alkyl ketene dimer (AKD) | 0.5 |
| Anion polyacrylamide | 0.2 |
| Epoxidized fatty acid amide (EFA) | 0.3 |
| Polyamide polyamine epichlorhydrin | 0.3 |

Notes)
AKD refers to an alkyl ketene dimer (the alkyl portion is derived from a fatty acid which is mainly composed of behenic acid), EFA refers to an epoxidized fatty acid amide (the fatty acid portion is derived from a fatty acid which is mainly composed of behenic acid).

A raw paper of weighting of 150 g/m² was manufactured from the pulp paper material obtained using a Fortlinear paper machine. In the middle of the dry zone in the Fortlinear paper machine, poly vinyl alcohol (PVA) was coated and dried so as to have weighting of 1 g/m² in solids, on the surface of the raw paper (a surface on which the toner image-receiving layer was to be disposed) by a gate roll coater.

In the final step of the papermaking process, the following two calendars were disposed in series and calender treatment was performed.

<Calendaring Apparatus>

(1) Soft Calendering Device (First Stage Calendar Apparatus)

The soft calendering device was disposed so that the raw paper top surface (on which the toner image-receiving layer was to be disposed) came in contact with a metal roller (surface temperature 250° C.), and the back surface of the raw paper came in contact with a urethane resin roller (surface temperature 40° C.).

The nip pressure was 235 kN/m (240 kgf/cm).

(2) Machine Calendering Device (Second Stage Calendering Device)

The machine calendering device was disposed so that the raw paper top surface (on which the toner-image-receiving layer was to be disposed) came in contact with a metal roller (surface temperature: 190° C.), and the back surface of the raw paper came in contact with a metal roller (surface temperature: 50° C.).

The nip pressure was 147 kN/m (150 kgf/cm).

The glossiness specified by JIS P8142 on the surface of the obtained raw paper was 38%.

—Preparation of Toner Image-Receiving Layer Coating Solution—

(Titanium Dioxide Dispersion Solution)

The following components were mixed and dispersed using a NBK-2 available from NIPPON SEIKI to prepare a titanium dioxide dispersion solution (titanium dioxide pigment: 40% by mass).

| | |
|---|---|
| Titanium dioxide | 40.0 g |
| (TIPAQUE (registered Trademark) A-220, available | |
| from Ishihara Sangyo Kaisha, Ltd.) | |
| PVA102 | 2.0 g |
| Ion exchange water | 58.0 g |

(Toner Image-Receiving Layer Coating Solution)

The following components were mixed and stirred to prepare the toner image-receiving layer coating solution.

| | | |
|---|---|---|
| Aforementioned titanium dioxide dispersion solution | 15.5 | g |
| Carnauba wax dispersion solution | 15.0 | g |
| (Cellosol 524, available from Chukyo Yushi Co., Ltd.) | | |
| Polyester resin water dispersion | 100.0 | g |
| (solids 30%, KZA-7049, Unitika Ltd.) | | |
| Thickener (Alcox E30, MEISEI CHEMICAL WORKS, | 2.0 | g |
| LTD) | | |
| Anionic surfactant (AOT) | 0.5 | g |
| Ion exchange water | 80 | ml |

The obtained toner image-receiving layer coating solution had the viscosity of 40 mPa·s, the surface tension was 34 mN/m.

—Preparation of Backing Layer Coating Solution—

The following components were mixed and stirred to prepare a backing layer coating solution.

| | | |
|---|---|---|
| Acrylate resin aqueous dispersion | 100.0 | g |
| (solids 30%, high-loss XBH-997L, available from | | |
| Seiko Chemicals) | | |
| Matting agent | 5.0 | g |
| (Techpolymer MBX-12, available from Sekisui Plastics | | |
| Co., Ltd.) | | |
| Releasing agent (Hydrin D337, Chukyo Yushi Co., Ltd.) | 10.0 | g |
| Thickener (CMC) | 2.0 | g |
| Anionic surfactant (AOT) | 0.5 | g |
| Ion exchange water | 80 | ml |

The backing layer coating solution had the viscosity of 35 mPa·s, and the surface tension of 33 mN/m.

<Coating of Backing Layer and Toner Image-Receiving Layer>

The aforesaid backing layer coating solution was applied to the back surface of the obtained raw paper by a bar coater, then the aforesaid toner image-receiving layer coating solution was applied to the top surface of the raw paper by a bar coater as in the case of the backing layer.

The toner image-receiving layer coating solution and the backing layer coating solution were each coated so that, for the backing layer, the coating amount is 9 g/m² in dry mass, and for the toner image-receiving layer, the coating amount was 12 g/m² in dry mass. The content of the pigment in the toner image-receiving layer was 5% by mass, relative to the mass of the thermoplastic resin.

After the backing layer coating solution and the toner image-receiving layer coating solution were coated, they were dried by hot air, online. The air and temperature for drying were adjusted, so that drying took place within 2 minutes after coating both the back surface and a toner image-receiving surface (top surface). The drying temperature was set so that surfaces of the toner image-receiving layer and the backing layer, each of which was disposed by coating solutions, was identical to the wet-bulb temperature of the air for drying.

After drying, gloss calendar treatment was carried out to a surface of the toner image-receiving layer. In the gloss calender treatment, the paper (electrophotographic image-receiving sheet) was passed through using a gloss calender, so that a metal roller with a surface temperature of 40° C. came in contact with the surface of the toner image-receiving layer, at the nip pressure of 14.7 kN/m (15 kgf/cm).

<Evaluation>

The obtained electrophotographic image-receiving sheet was cut to A4 size, and used for printing. The printer used here was a color laser printer (DocuColor 1250-PF) produced by Fuji Xerox Co., Ltd., except that an apparatus having the fixing belt shown in FIG. 2 was installed. Specifically, in the apparatus having a fixing belt 10, a fixing belt 2 is suspended around a heating roller 3 and a tension roller 5 as shown in FIG. 2. A cleaning roller 6 is provided via the fixing belt 2 above the tension roller 5, and a pressurizing roller 4 is further provided via the fixing belt 2 below the heating roller 3. In FIG. 2, starting from the right-hand side, the electrophotographic image-receiving sheet carrying a toner latent image was introduced between the heating roller 3 and the pressurizing roller 4, was fixed and transported on the fixing belt 2. Thereafter, in this process, the toner latent image was cooled by a cooling device 7, and the fixing belt 2 was finally cleaned by a cleaning roller 6.

In the apparatus having a fixing belt, the transport speed at the fixing belt 2 is 30 mm/sec, the nip pressure between the heating roller 3 and the pressurizing roller 4 was 0.2 MPa (2 kgf/cm²), and the temperature of the heating roller 3 was 150° C. which corresponded to the fixing temperature. The temperature of the pressurizing roller 4 was 120° C.

<Image Quality>

The electrophotographic image-receiving sheet was cut to A4 size, a woman's portrait was printed out, and evaluated in accordance with the following criteria.

[Evaluation Criteria]

A: Best

B: Good, can be used (within tolerance).

C: Poor, cannot be used (cannot be used in practice).

D: Very poor, cannot be used.

<Glossiness>

The glossiness of the electrophotographic image-receiving sheet after printing was visually observed, and the paper with the best glossiness was assigned A, followed by B, C and D on the following basis.

[Evaluation Criteria]

A: Best

B: Good, can be used (within tolerance).

C: Poor, cannot be used (cannot be used in practice).

D: Very poor, cannot be used.

### EXAMPLES 22-28 AND COMPARATIVE EXAMPLES 9-13

The electrophotographic image-receiving sheets of Examples 22-28 and Comparative Examples 9-13 were each manufactured in the same way as in Example 21, except that the treatment conditions of the two sets of calendering apparatus used for preparation of the raw paper were those of the following Table 4, and image quality and glossiness were likewise evaluated. The results are shown in Table 4 and Table 5.

TABLE 4

| | | | | | | | Raw |
|---|---|---|---|---|---|---|---|
| | First calender treatment | | | Second stage calender treatment | | | paper |
| | Type of | Metal roller | Nip | Type of | Metal roller | Nip | properties |
| | Calendering | temperature | pressure | Calendering | temperature | pressure | Glossiness |
| | device | (° C.) | (kN/m) | device | (° C.) | (kN/m) | (%) |
| Example 21 | Soft | 250 | 235 | Machine | 190 | 147 | 38 |
| Example 22 | Soft | 210 | 196 | Machine | 150 | 196 | 32 |
| Example 23 | Soft | 160 | 235 | — | — | — | 26 |
| Example 24 | Machine | 150 | 196 | Soft | 210 | 196 | 30 |
| Example 25 | Machine | 210 | 216 | — | — | — | 28 |
| Example 26 | Soft | 250 | 147 | Soft | 210 | 147 | 39 |
| Example 27 | Soft | 250 | 196 | Shoe | 210 | 392 | 45 |
| Example 28 | Machine | 250 | 196 | Shoe | 210 | 392 | 43 |
| Comp. Ex. 9 | Machine | 50 | 196 | — | — | — | 7 |
| Comp. Ex. 10 | Machine | 90 | 196 | — | — | — | 9 |
| Comp. Ex. 11 | Machine | 90 | 196 | Machine | 120 | 147 | 12 |
| Comp. Ex. 12 | Machine | 120 | 196 | Machine | 120 | 147 | 19 |
| Comp. Ex. 13 | Soft | 140 | 196 | Machine | 140 | 147 | 23 |

TABLE 5

Properties
after printing

| | Glossiness | Image quality |
|---|---|---|
| Example 21 | A | A |
| Example 22 | A | A |
| Example 23 | B | B |
| Example 24 | A | A |
| Example 25 | B | B |
| Example 26 | A | A |
| Example 27 | A | A |
| Example 28 | A | A |
| Comp. Ex. 9 | D | D |
| Comp. Ex. 10 | D | D |
| Comp. Ex. 11 | D | D |
| Comp. Ex. 12 | D | C |
| Comp. Ex. 13 | C | B |

As clearly shown in the Table 4 and Table 5, an electrophotographic image-receiving sheet having glossiness of 25% or more on a surface of the raw paper and having a toner image-receiving layer which substantially does not contain pigments on a surface thereof, exhibits excellent image quality and glossiness. It is also clearly shown that an electrophotographic image-receiving sheet subjected to soft calender treatment so as to contact a metal roller having surface temperature of 150° C. or more, exhibits excellent image quality and glossiness.

The present invention therefore provides a high-quality electrophotographic image-receiving sheet which can be manufactured more easily and efficiently than the electrophotographic image-receiving sheet of the related art, and which gives the image quality and glossiness of a photographic image.

1-20. (canceled)

21. A process for manufacturing an electrophotographic image-receiving sheet, comprising the steps of:
subjecting a surface of a support on which a toner image-receiving layer is to be disposed to soft calender treatment using a metal roller having a surface temperature of 150° C. or higher; and
subjecting a surface of the toner image-receiving layer to soft calender treatment using a metal roller having a surface temperature of glass transition temperature (Tg) of the thermoplastic resin minus 30° C. or more and the glass transition temperature plus 50° C. or less, so that the metal roller contacts a surface of the toner image-receiving layer,
wherein the electrophotographic image-receiving sheet comprises:
the support; and
the toner image-receiving layer which is to be disposed on at least one surface of the support and contains the thermoplastic resin.

22. A process for manufacturing an electrophotographic image-receiving sheet according to claim 21, wherein the soft calender treatment is carried out by a shoe calender having a long nip.

23. A process for manufacturing an electrophotographic image-receiving sheet according to claim 21, wherein the soft calender treatment is carried out at nip pressure of 100 kN/m or more.

24. (canceled)

25. (canceled)

26. (canceled)

27. (canceled)

28. (canceled)

29. A process for manufacturing an electrophotographic image-receiving sheet according to claim 21, wherein the toner image-receiving layer further contains a pigment.

30. A process of manufacturing an electrophotographic image-receiving sheet according to claim 29, wherein a surface of the support on which the toner image-receiving layer is to be disposed is subject to a soft calender treatment using a metal roller having a surface temperature of 150° C. or higher, said surface of the support having a 75° glossiness as specified by ISO 8254-1:1999 of 25% or more, and the content of the pigment in the toner image-receiving layer is less than 40% by mass based on the mass of the thermoplastic resin which forms the toner image-receiving layer.
